(19) United States
(12) Patent Application Publication
(10) Pub. No.: US 2025/0389993 A1
(43) Pub. Date: Dec. 25, 2025

(54) DISPLAY SUBSTRATE, DISPLAY PANEL AND DISPLAY APPARATUS

(71) Applicants: Chengdu BOE Optoelectronics Technology Co., Ltd., Chengdu (CN); BOE TECHNOLOGY GROUP CO., LTD., Beijing (CN)

(72) Inventors: Bo WU, Beijing (CN); Changyi WANG, Beijing (CN); Hao LUO, Beijing (CN); Zhengyan WAN, Beijing (CN); Chunmiao TANG, Beijing (CN); Yuanming FENG, Beijing (CN)

(21) Appl. No.: 19/099,220

(22) PCT Filed: Apr. 22, 2024
(86) PCT No.: PCT/CN2024/089038

§ 371 Date: Jan. 28, 2025

(51) Int. Cl. G02F 1/1362; G02F 1/1368

(52) U.S. Cl. CPC G02F 1/13629; G02F 1/136227; G02F 1/1368

(57) ABSTRACT

A display substrate is provided, including: a base substrate and a first conductive layer, a first insulating layer, a second conductive layer, a second insulating layer and a third conductive layer sequentially arranged away from the base substrate. The first conductive layer includes: data lines and electrode lines, and first and a second electrodes of a thin film transistor. The second conductive layer includes a common electrode and protective electrode blocks, the common electrode includes openings, and an orthographic projection of at least one protective electrode blocks on the base substrate falls within an orthographic projection of at least one openings of the common electrode on the base substrate. The third conductive layer includes pixel electrodes, and the pixel electrode is connected to a protective electrode block and the second electrode of the thin film transistor through a first via hole.

### TECHNICAL FIELD

The present disclosure relates to the field of display technology, and in particular to a display substrate, a display panel, and a display apparatus.

### BACKGROUND

Liquid crystal displays (LCDs) are widely used due to their small size, low power consumption, and no radiation. As the resolution of display products is getting higher, the pixel size is getting smaller, and the aperture ratio is also getting smaller. How to optimize the pixel design and increase the pixel aperture ratio is crucial for high-resolution display products.

The above information disclosed in this section is only used for understanding the background of the technical concept of the present disclosure, therefore, the above information may contain information that does not constitute the prior art.

### SUMMARY

In an aspect, a display substrate is provided. The display substrate includes a plurality of subpixels arranged in an array in a first direction and a second direction interesting the first direction. The display substrate includes: a base substrate: a first conductive layer on a side of the base substrate, where the first conductive layer includes a plurality of data lines and a plurality of electrode lines alternately arranged in the first direction, the data lines and the electrode lines each extend in the second direction, and each column of subpixels is located between a data line and an electrode line adjacent to each other; and the first conductive layer further includes a first electrode and a second electrode of a thin film transistor, the data line is connected to the first electrode of the thin film transistor, and the second electrode of the thin film transistor is located between the data line and the electrode line adjacent to each other: a first insulating layer on a side of the first conductive layer away from the base substrate: a second conductive layer on a side of the first insulating layer away from the base substrate, where the second conductive layer includes a common electrode and a plurality of protective electrode blocks, the common electrode includes a plurality of openings, and an orthographic projection of at least one of the protective electrode blocks on the base substrate falls within an orthographic projection of at least one of the openings of the common electrode on the base substrate: a second insulating layer on a side of the second conductive layer away from the base substrate; and a third conductive layer on a side of the second insulating layer away from the base substrate. The third conductive layer includes a plurality of pixel electrodes, a region where each subpixel is located is provided with a respective one of the pixel electrodes, the pixel electrode is connected to the protective electrode block through a first via hole, and the pixel electrode is connected to the second electrode of the thin film transistor through the first via hole. An orthographic projection of the second electrode of the thin film transistor on the base substrate at least partially overlaps with the orthographic projection of the protective electrode block on the base substrate. An overlap between the orthographic projection of the second electrode of the thin film transistor on the base substrate and the orthographic projection of the protective electrode block on the base substrate at least partially overlaps with an orthographic projection of the first via hole on the base substrate.

According to some exemplary embodiments, the first via hole includes a first sub-via hole and a second sub-via hole, where the first sub-via hole and the second sub-via hole are adjacent and connected to each other in the first direction. The first sub-via hole penetrates the first insulating layer and the second insulating layer, and the pixel electrode is connected to the second electrode of the thin film transistor through the first sub-via hole. The second sub-via hole penetrates the second insulating layer, and the pixel electrode is connected to the protective electrode block through the second sub-via hole.

According to some exemplary embodiments, the first sub-via hole has a first width in the first direction, and the second sub-via hole has a second width in the first direction, and the first width is smaller than the second width.

According to some exemplary embodiments, the orthographic projection of the second electrode of the thin film transistor on the base substrate includes a first side edge and a second side edge extending in the second direction, the orthographic projection of the first via hole on the base substrate includes a third side edge and a fourth side edge extending in the second direction, and the orthographic projection of the protective electrode block on the base substrate includes a fifth side edge and a sixth side edge extending in the second direction. The first side edge, the third side edge, the fifth side edge, the second side edge, the fourth side edge and the sixth side edge are sequentially arranged at interval in the first direction.

According to some exemplary embodiments, a distance between the first side edge and the third side edge is a first preset distance.

According to some exemplary embodiments, a distance between the fifth side edge and the second side edge is a second preset distance.

According to some exemplary embodiments, a distance between the fourth side edge and the sixth side edge is a third preset distance.

According to some exemplary embodiments, the first insulating layer includes a first portion adjacent to the first sub-via hole, and an orthographic projection of the first portion on the base substrate does not overlap with an orthographic projection of the second sub-via hole on the base substrate. The first portion includes a first sidewall close to the first sub-via hole, and the first sidewall has a first slope angle. The second insulating layer includes a second portion adjacent to the first sub-via hole, and an orthographic projection of the second portion on the base substrate does not overlap with the orthographic projection of the second sub-via hole on the base substrate. The second portion includes a second sidewall close to the first sub-via hole, and the second sidewall has a second slope angle. The first slope angle is greater than the second slope angle.

According to some exemplary embodiments, the first insulating layer further includes a third portion adjacent to the first sub-via hole, an orthographic projection of the third portion on the base substrate falls within the orthographic projection of the second electrode of the thin film transistor on the base substrate, and the orthographic projection of the third portion on the base substrate falls within the orthographic projection of the protective electrode block on the base substrate. The third portion includes a third sidewall away from the first sub-via hole, and the third sidewall has a third slope angle. The protective electrode block includes a fourth portion, and an orthographic projection of the fourth portion on the base substrate falls within the orthographic projection of the third portion of the first insulating layer on the base substrate. The fourth portion of the protective electrode block includes a fourth sidewall away from the first sub-via hole, and the fourth sidewall has a fourth slope angle. The third slope angle is greater than or equal to twice the fourth slope angle.

According to some exemplary embodiments, the second insulating layer further includes a fifth portion adjacent to the second sub-via hole, an orthographic projection of the fifth portion on the base substrate at least partially overlaps with the orthographic projection of the protective electrode block on the base substrate. The fifth portion includes a fifth sidewall close to the second sub-via hole, the fifth sidewall has a fifth slope angle, and the fifth slope angle is greater than or equal to 30°.

According to some exemplary embodiments, the display substrate further includes: a third insulating layer on a side of the first conductive layer close to the base substrate; and a fourth conductive layer on a side of the third insulating layer close to the base substrate. The fourth conductive layer includes a gate electrode of the thin film transistor and a gate line connected to the gate electrode, the gate line includes a widening portion and a connecting portion, the gate electrode is located in the widening portion, the orthographic projection of the second electrode of the thin film transistor on the base substrate at least partially overlaps with an orthographic projection of the widening portion on the base substrate, and the orthographic projection of the second electrode of the thin film transistor on the base substrate does not overlap with an orthographic projection of the connecting portion on the base substrate.

According to some exemplary embodiments, the orthographic projection of the protective electrode block on the base substrate at least partially overlaps with the orthographic projection of the widening portion on the base substrate, and the orthographic projection of the protective electrode block on the base substrate at least partially overlaps with the orthographic projection of the connecting portion on the base substrate.

According to some exemplary embodiments, the display substrate includes a plurality of gate lines extending in the first direction, where the gate line is located between two adjacent rows of subpixel regions. The pixel electrode includes a plurality of pixel electrode strips arranged at intervals in a region where the subpixel is located. The pixel electrode further includes a first connecting portion and a second connecting portion. The first connecting portion is located on one side of the plurality of pixel electrode strips and connected to each of the plurality of pixel electrode strips, the second connecting portion is located on the other side of the plurality of pixel electrode strips and connected to each of the plurality of pixel electrode strips, the first connecting portion is connected to a second electrode of a corresponding thin film transistor through the first via hole, and an orthographic projection of the second connecting portion on the base substrate at least partially overlaps with an orthographic projection of a gate line on a corresponding side on the base substrate.

According to some exemplary embodiments, the display substrate includes a plurality of gate lines extending in the first direction, where the gate line is located between two adjacent rows of subpixel regions. Two gate lines are arranged between every two adjacent rows of subpixel regions. The plurality of subpixels includes a plurality of rows of subpixels respectively located in an i^{th} row and an (i+1)^{th} row and a plurality of columns of subpixels respectively located in a j^{th} column and a (j+1)^{th} column, where i is greater than or equal to 1, and j is greater than or equal to 1. The gate lines include a first gate line and a second gate line located between a region where the i^{th} row of subpixels is located and a region where the (i+1)^{th} row of subpixels is located, the first gate line is connected to a gate electrode of a thin film transistor of a subpixel in the i^{th} row and the (j+1)^{th} column, and the second gate line is connected to a gate electrode of a thin film transistor of a subpixel in the (i+1)^{th} row and the (j+1)^{th} column.

According to some exemplary embodiments, the first via hole includes a seventh side edge extending in the first direction. The seventh side edge in the i^{th} row of subpixels is located between the first gate line and the second gate line, and a distance between the seventh side edge and the second gate line is a fourth preset distance.

According to some exemplary embodiments, the first via hole further includes an eighth side edge extending in first direction, and an orthographic projection of the eighth side edge on the base substrate falls within the orthographic projection of the gate line on the base substrate. The protective electrode block includes a ninth side edge extending in the first direction, and an orthographic projection of the ninth side edge on the base substrate at least partially overlaps with the orthographic projection of the widening portion of the gate line on the base substrate. A distance between the eighth side edge and the ninth side edge is a fifth preset distance.

According to some exemplary embodiments, the orthographic projection of the protective electrode block on the base substrate at least partially overlaps with the orthographic projection of the gate line on the base substrate. The protective electrode block includes a protruding portion protruding relative to the gate line in the second direction, and the protruding portion is located between two adjacent gate lines. The protruding portion has a first protruding distance in the second direction.

According to some exemplary embodiments, the display substrate includes a first subpixel located in an i^{th} row and a j^{th} column, a second subpixel located in the i^{th} row and a (j+1)^{th} column, and a third subpixel located in the i^{th} row and a (j+2)^{th} column, where the second subpixel includes a second subpixel electrode. The display substrate further includes a first data line located between the j^{th} column of subpixels and the (j+1)^{th} column of subpixels, and a first electrode line located between the (j+1)^{th} column of subpixels and the (j+2)^{th} column of subpixels. An orthographic projection of the second subpixel electrode on the base substrate at least partially overlaps with an orthographic projection of the first electrode line on the base substrate.

According to some exemplary embodiments, the data line includes a body portion and a connecting portion, and the connecting portion is connected to the first electrode of the thin film transistor. The connecting portion extends in the second direction, an orthographic projection of the connecting portion on the base substrate at least partially overlaps with an orthographic projection of the main portion on the base substrate, the connecting portion has a third width in the first direction, the body portion has a fourth width in the first direction, and a ratio of the third width to the fourth width is between 0.8 and 1.2.

According to some exemplary embodiments, the data line includes a body portion and a connecting portion, and the connecting portion is connected to the first electrode of the thin film transistor. The connecting portion protrudes relative to the body portion by a second protruding distance in the first direction, the body portion has a fourth width in the first direction, and the second protruding distance is greater than the fourth width.

According to some exemplary embodiments, an orthographic projection of the common electrode on the base substrate at least partially overlaps with the orthographic projection of the gate line on the base substrate.

According to some exemplary embodiments, the display substrate includes a plurality of gate lines extending in the first direction, where the gate line is located between two adjacent rows of subpixel regions and includes a widening portion and a connecting portion, and two gate lines are arranged between every two adjacent rows of subpixel regions. The plurality of subpixels include a plurality of rows of subpixels respectively located in an i^{th} row and an (i+1)^{th} row, where i is greater than or equal to 1, the gate lines include a first gate line and a second gate line located between a region where the i^{th} row of subpixels is located and a region where the (i+1)^{th} row of subpixels is located. An orthographic projection of the common electrode on the base substrate at least partially overlaps with an orthographic projection of the widening portion of the first gate line on the base substrate, and an overlap between the orthographic projection of the common electrode and the orthographic projection of the widening portion of the first gate line has a first overlapping width in the second direction, and the first overlapping width is greater than or equal to 0.85 microns.

According to some exemplary embodiments, the orthographic projection of the common electrode on the base substrate at least partially overlaps with an orthographic projection of a connecting portion of the second gate line on the base substrate, an overlap between the orthographic projection of the common electrode and the orthographic projection of the connecting portion of the second gate line has a second overlapping width in the second direction, and the second overlapping width is greater than or equal to 0.5 microns.

In another aspect, a display panel is provided. The display panel includes any display substrate described above.

In yet another aspect, a display apparatus is provided. The display apparatus includes any display substrate described above or the display panel described above.

### BRIEF DESCRIPTION OF THE DRAWINGS

The above and other objects, features and advantages of the present disclosure will be more apparent from the following description of the embodiments of the present disclosure with reference to the accompanying drawings.

FIG. 1 is a partial plan view of a display substrate according to some exemplary embodiments of the present disclosure;

FIG. 2 is an enlarged diagram of the dash box portion of FIG. 1:

FIG. 3A is a cross-sectional view taken along line AA′ in FIG. 2;

FIG. 3B is a cross-sectional view taken along line BB′ in FIG. 2:

FIG. 4 is a plan view of a display substrate according to some exemplary embodiments of the present disclosure:

FIG. 5A is a local schematic plan view of a display substrate according to some exemplary embodiments of the present disclosure: FIG. 5B is a schematic cross-sectional view taken along line A1-A1′ in FIG. 5A: FIG. 5C is a schematic cross-sectional view taken along line B1-B1′ in FIG. 5A: FIG. 5D is a local schematic plan view of a display substrate according to some other exemplary embodiments of the present disclosure: FIG. 5E is a schematic cross-sectional view taken along line A2-A2′ in FIG. 5D; FIG. 5F is a schematic cross-sectional view taken along line B2-B2′ in FIG. 5D: FIG. 5G is a local schematic plan view of a display substrate according to some further exemplary embodiments: FIG. 5H is a schematic cross-sectional view taken along line A3-A3′ in FIG. 5G; and FIG. 5I is a schematic cross-sectional view taken along line B3-B3′ in FIG. 5G;

FIG. 6 is a local schematic plan view of a display substrate according to some exemplary embodiments of the present disclosure;

FIG. 7 is a local schematic plan view of a fourth conductive layer in FIG. 6:

FIG. 8 is a local schematic plan view of a third insulating layer in FIG. 6;

FIG. 9 is a local schematic plan view of a first conductive layer in FIG. 6;

FIG. 10 is a local schematic plan view of a second conductive layer in FIG. 6;

FIG. 11 shows a plurality of via holes in FIG. 6:

FIG. 12 is a local schematic plan view of a third conductive layer in FIG. 6:

FIG. 13A and FIG. 13B are each a local enlarged schematic diagram of the dotted line area S in FIG. 6;

FIG. 14 is a schematic cross-sectional view taken along line CC′ in FIG. 13A:

FIG. 15 is a schematic cross-sectional view taken along line DD′ in FIG. 13A:

FIG. 16 is a SEM diagram of a display substrate in a first via hole region in a first direction according to some exemplary embodiments of the present disclosure:

FIG. 17 is a local schematic plan view of a display substrate according to some exemplary embodiments of the present disclosure:

FIG. 18 is a local schematic plan view of a display substrate according to some exemplary embodiments of the present disclosure:

FIG. 19A is a schematic cross-sectional view of a display substrate provided according to some embodiments of the present disclosure taken along line EE′ in FIG. 17: FIG. 19B is a schematic cross-sectional view of a display substrate provided according to some embodiments of the present disclosure taken along line FF′ in FIG. 17: FIG. 19C is a schematic cross-sectional view of a display substrate provided according to some embodiments of the present disclosure taken along line GG′ in FIG. 18; and FIG. 19. D is a schematic cross-sectional view of a display substrate provided according to some embodiments of the present disclosure taken along line HH′ in FIG. 18:

FIG. 20 is a schematic structural diagram of a display apparatus provided according to some embodiments of the present disclosure; and

FIG. 21 is a schematic structural diagram of a display apparatus provided according to some embodiments of the present disclosure.

It should be noted that, for the sake of clarity, in the accompanying drawings used to describe the embodiments of the present disclosure, the sizes of layers, structures or regions may be enlarged or reduced, that is, these drawings are not drawn according to actual scales.

### DETAILED DESCRIPTION OF EMBODIMENTS

In order to make the purposes, technical solutions and advantages of the embodiments of the present disclosure clearer, the technical solutions of the embodiments of the present disclosure will be clearly and completely described below in conjunction with the drawings of the embodiments of the present disclosure. Obviously, the described embodiments are a part of the embodiments of the present disclosure, not all of the embodiments. Based on the described embodiments of the present disclosure, all the other embodiments obtained by those of ordinary skills in the art without creative work are within the scope of protection of the present disclosure.

It should be noted that in the accompanying drawings, the sizes and relative sizes of the elements may be enlarged for the purpose of clarity and/or description. Thus, the size and relative size of each element are not necessarily limited to the size and relative size shown in the accompanying drawings. In the specification and accompanying drawings, the same or similar reference signs indicate the same or similar parts.

Unless otherwise defined, the technical terms or scientific terms used in the present disclosure should have their general meanings as understood by those of ordinary skills in the art. “First”, “second” and similar words used in the present disclosure do not indicate any order, quantity or importance, and are only used to distinguish different constituent parts. “Include”/“comprise” or “contain” and similar words mean that an element or article appearing before this word covers the elements or articles and their equivalents listed after this word, without excluding other elements or articles.

In the present text, unless otherwise specified, directional terms such as “upper”, “lower”, “left”, “right”, “inner”, and “outer” are used to indicate the orientation or positional relationship based on the accompanying drawings. They are only use for the convenience of describing the present disclosure, and do not indicate or imply that the apparatus, element or component referred to must have a specific orientation, be constructed or operated in a specific orientation. It should be understood that when the absolute position of a described object changes, the relative positional relationship they represent may also change accordingly. Therefore, these directional terms should not be understood as limiting the present disclosure.

It should be noted that, in the present text, the expression “the same layer” refers to a layer structure formed by using the same film-forming process to form a layer for forming a specific pattern, and then using the same mask to pattern the layer through a single composition process. Depending on the specific pattern, a single composition process may include multiple processes of exposure, development or etching, and the specific pattern in the formed layer structure may be continuous or discontinuous. That is, multiple elements, components, structures and/or parts located in the “same layer” are made of the same material and are formed through the same composition process. Usually, multiple elements, components, structures and/or parts located in the “same layer” have approximately the same thickness.

Those skilled in the art should understand that, in the present text, unless otherwise specified, the expression “height” or “thickness” refers to a dimension of the surface of each layer arranged perpendicular to the display substrate, i.e., a dimension in the light emitting direction of the display substrate, or a dimension in the normal direction of the display apparatus.

In the present text, directional expressions “first direction” and “second direction” are used to describe different directions along a pixel unit, for example, a longitudinal direction and a transverse direction of the pixel unit, or a row direction and a column direction of a subpixel arrangement. It should be understood that such expressions are only exemplary descriptions and are not limitations of the present disclosure.

In the present text, the expression “transistor” may be a triode, a thin film transistor or a field effect transistor or another device with the same characteristics. In the embodiments of the present disclosure, in order to distinguish the two electrodes of the transistor except the control electrode, one of the electrodes is called a first electrode and the other is called a second electrode. In actual operations, when the transistor is a thin film transistor or a field effect transistor, the first electrode may be a drain electrode and the second electrode may be a source electrode: or the first electrode may be a source electrode and the second electrode may be a drain electrode.

A liquid crystal display is a flat ultra in display apparatus, mainly including a backlight module, a display panel, etc. The backlight module provides light for the display panel, and the display panel displays pictures. In practical applications, only a small part of the light emitted by the backlight module passes through the display panel, and the utilization rate of light is low. To ensure that the liquid crystal display has a higher luminance, more power is consumed. Pixels arranged on the display panel include a light-transmitting region and a non-light-transmitting region. The light-transmitting region includes a region where a pixel electrode is located, and the non-light-transmitting region includes a region where a data line, a gate line, a thin film transistor, etc. are located. The ratio of an area of the light-transmitting region to an area of the pixel area is an aperture ratio. The larger the aperture ratio is, the higher the utilization rate of light of the liquid crystal display will be. Therefore, the utilization rate of light may be improved by increasing the aperture ratio of the pixel, so that the liquid crystal display has a higher luminance under the condition of lower power consumption.

However, as the resolution of display products becomes higher, the pixel size becomes smaller, and the aperture ratio becomes smaller. The factors that affect the aperture ratio include the gate line width, the data line width, the black matrix line width and the pixel design structure. In high-resolution products, the pixel spacing is small, and the gate line width, data line width and black matrix line width have a great impact on the aperture ratio. The limit values of the gate line width, the spacing between gate lines, the data line width and the spacing between data lines are limited by the production line process and equipment. Certain limit values exist and cannot be reduced indefinitely. Moreover, for the black matrix line width, the cell alignment precision and the light leakage need to be taken into account.

Some exemplary embodiments of the present disclosure provide a display substrate. The display substrate includes a plurality of subpixels arranged in an array in a first direction and a second direction interesting the first direction. The display substrate includes: a base substrate: a first conductive layer on a side of the base substrate, where the first conductive layer includes a plurality of data lines and a plurality of electrode lines alternately arranged in the first direction, the data lines and the electrode lines each extend in the second direction, and each column of subpixels is located between a data line and an electrode line adjacent to each other. The first conductive layer further includes a first electrode and a second electrode of a thin film transistor, the data line is connected to the first electrode of the thin film transistor, and the second electrode of the thin film transistor is located between the data line and electrode line adjacent to each other: a first insulating layer on a side of the first conductive layer away from the base substrate: a second conductive layer on a side of the first insulating layer away from the base substrate, where the second conductive layer includes a common electrode and a plurality of protective electrode blocks, the common electrode includes a plurality of openings, and an orthographic projection of at least one of the protective electrode blocks on the base substrate falls within an orthographic projection of at least one of the openings of the common electrode on the base substrate: a second insulating layer on a side of the second conductive layer away from the base substrate; and a third conductive layer on a side of the second insulating layer away from the base substrate. The third conductive layer includes a plurality of pixel electrodes, a region where each subpixel is located is provided with a respective one of the pixel electrodes, the pixel electrode is connected to the protective electrode block through a first via hole, and the pixel electrode is connected to the second electrode of the thin film transistor through the first via hole. An orthographic projection of the second electrode of the thin film transistor on the base substrate at least partially overlaps with the orthographic projection of the protective electrode block on the base substrate. An overlap between the orthographic projection of the second electrode of the thin film transistor on the base substrate and the orthographic projection of the protective electrode block on the base substrate at least partially overlaps with an orthographic projection of the first via hole on the base substrate.

For a limited wiring space of the high-resolution display substrate, by adopting a half-via half connection manner and adding the protective electrode block at the second electrode of the thin film transistor, an area for wiring the second electrode of the thin film transistor may be reduced while avoiding: the gate insulating layer from being penetrated when a via hole is formed in the insulating layer, the pixel electrode being connected to the gate line, and a poor display. Furthermore, by adopting a top pixel design and optimizing the wiring design, a black matrix line width may be reduced, so that an aperture ratio of pixels may be effectively increased, a storage capacitance may be effectively improved, and the display effect may be optimized. In addition, existing mature process flows may be applied to the display substrate in the embodiments of the present disclosure without increasing production and process costs.

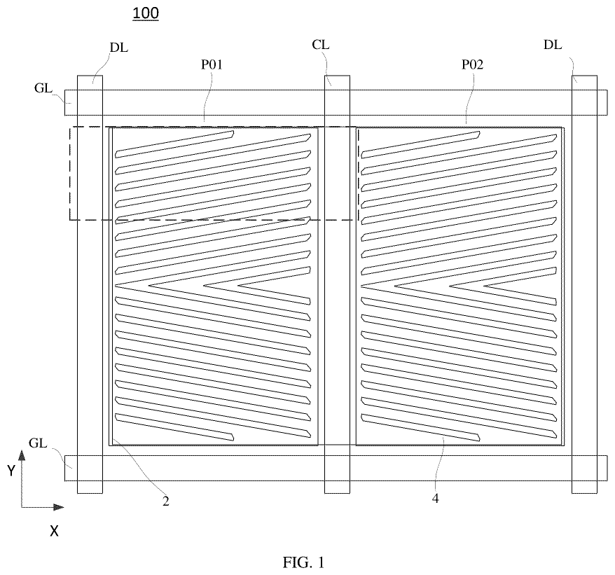

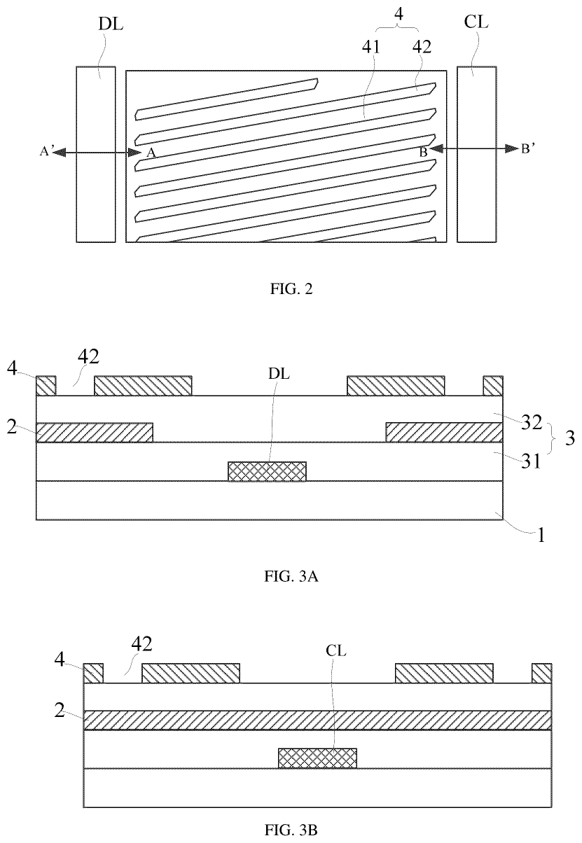

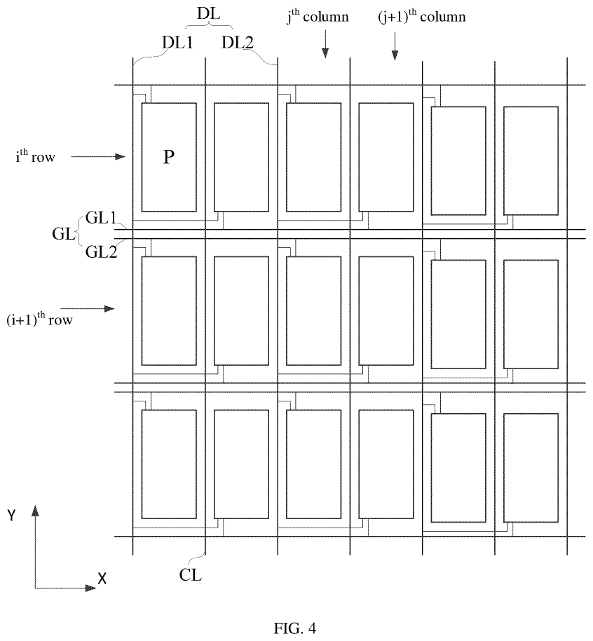

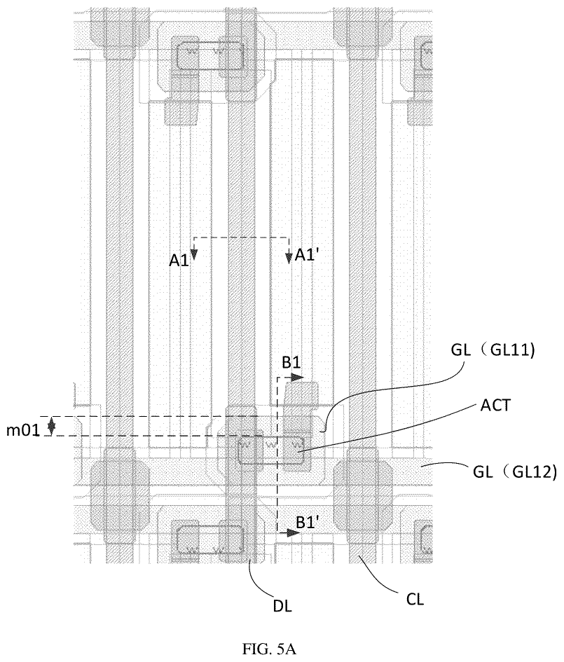

FIG. 1 to FIG. 4 show schematic diagrams of a display substrate according to an embodiment of the present disclosure. FIG. 1 is a partial plan view of a display substrate, FIG. 2 is an enlarged diagram of the dash box portion of FIG. 1, FIG. 3A is a cross-sectional view taken along line AA′ in FIG. 2, FIG. 3B is a cross-sectional view taken along line BB′ in FIG. 2, and FIG. 4 is a local plan view of a display substrate.

As shown in the figures, the display substrate according to the embodiments of the present disclosure may include: a base substrate 1 and a plurality of subpixels P located on the base substrate 1 (as shown in FIG. 4). The plurality of subpixels P are arranged on the base substrate 1 in an array, i.e., including a plurality of rows of subpixels P and a plurality of columns of subpixels P. In the present text, for the convenience of description, a horizontal direction in FIG. 1 is referred to as a first direction X (a row direction), and a vertical direction in FIG. 1 is referred to as a second direction Y (a column direction). In FIG. 1, two subpixels P adjacent to each other in the row direction are schematically shown, and for the convenience of description, they may be referred to as a subpixel P01 and a subpixel P02.

Specifically, the display substrate may include a plurality of gate lines GL extending in the row direction X, a plurality of data lines DL extending in the column direction Y, and a plurality of electrode lines CL extending in the column direction. For example, the plurality of data lines DL and the plurality of electrode lines CL are alternately arranged in the row direction, and the plurality of data lines DL and the plurality of electrode lines CL each intersect the plurality of gate lines GL, so as to define the plurality of subpixels P.

Exemplarily, the data line DL may be connected to at least part of transistors in a driver circuit, so as to provide a data signal to a respective subpixel.

Exemplarily, the electrode line CL is located between two adjacent subpixel regions, so that a metal wire (a data line DL or an electrode line CL) may be arranged between every two adjacent columns of subpixel regions, thereby ensuring the etching uniformity and improving the etching effect during the preparation process.

In some embodiments, the display substrate includes a common electrode, and the electrode line CL may be connected to the common electrode to provide a common electrode signal thereto.

Optionally, FIG. 4 shows a local plan view of the display substrate in FIG. 1, in which more subpixels P on the base substrate 1 are schematically shown. As shown in FIG. 4, a display substrate driven by dual gate lines is shown. Specifically, the display substrate includes a plurality of gate lines extending in the first direction X, the gate line is arranged between two adjacent rows of subpixel regions, and two gate lines are arranged between every two adjacent rows of subpixel regions. For example, the plurality of subpixels include: a plurality of rows of subpixels respectively located in an i^{th} row and an (i+1)^{th} row, and a plurality of columns of subpixels respectively located in a j^{th} column and a (j+1)^{th} column, where i is greater than or equal to 1, and j is greater than or equal to 1. The gate lines include a first gate line GL1 and a second gate line GL2 located between a region where the i^{th} row of subpixels is located and a region where the (i+1)^{th} row of subpixels is located. The first gate line GL1 is connected to a gate electrode of a thin film transistor of a subpixel in the i^{th} row and the (j+1)^{th} column, and the second gate line GL2 is connected to a gate electrode of a thin film transistor of a subpixel in the (i+1)^{th} row and the j^{th} column. Subpixels P01 and P02 adjacent to each other in the row direction X may form a subpixel group, and one data line DL is arranged between two subpixel groups adjacent to each other in the row direction. One electrode line CL is arranged between the two subpixels P01 and P02 in the subpixel group.

Referring to FIG. 3A and FIG. 3B, the display substrate may further include a common electrode 2 and a pixel electrode 4 arranged on the base substrate 1. The common electrode 2 and the pixel electrode 4 are configured to jointly form an electric field for driving liquid crystal molecules to deflect, so as to achieve the display of a specific gray scale. Specifically, the display substrate may further include an insulating layer 32 arranged on the base substrate 1 and located between the common electrode 2 and the pixel electrode 4. For example, common electrodes 2 in the respective subpixels on the display substrate may be electrically connected to each other, and pixel electrodes 4 in the respective subpixels on the display substrate may be independent of each other.

In the embodiment shown in FIG. 1 to FIG. 4, the common electrode 2, the insulating layer 32 and the pixel electrode 4 are sequentially arranged on the base substrate 1 in a direction away from the base substrate 1, that is, the common electrode 2 is on a lower side and the pixel electrode 4 is on an upper side. For example, the common electrode 2 is a planar electrode. The common electrode 2 in one subpixel group may be formed as an integral planar electrode, an orthographic projection of the common electrode 2 in the subpixel group on the base substrate 1 may cover two subpixels P1 and P2, and the orthographic projection of the common electrode 2 in the subpixel group on the base substrate 1 may further cover an orthographic projection of an electrode line CL in the subpixel group on the base substrate 1. For example, the pixel electrode 4 is a comb-shaped electrode with a plurality of slits 42, that is, the pixel electrode includes a plurality of pixel electrode strips 41 arranged at intervals in a region where the subpixel is located. Exemplarily, the display substrate adopts a design in which the common electrode is on an upper side and the pixel electrode is on a lower side. In a display substrate where the common electrode is on the upper side and the pixel electrode is on the lower side, arrangement of the pixel electrodes may be similar to that of the pixels in the display substrate where the common electrode is on the lower side and the pixel electrode is on the upper side in the above embodiment. In order to prevent light leakage of the display substrate, in the display substrate, a black matrix is further arranged on a side of the common electrode away from the base substrate. The black matrix needs to be large enough to cover part of the transistors or the signal lines, such as gate lines, data lines, and electrode line, in a driver circuit layer below, so as to reduce the electrical light leakage.

Since the common electrode is arranged above the pixel electrode, the common electrode is spaced apart from the transistors, the data line, the electrode line and other parts located on a side of the common electrode close to the base substrate by a large spacing in the light output direction. Therefore, the signal shielding on the transistors, the data line and the electrode line below by the potential at the common electrode is weak. In this case, in order to prevent the electrical light leakage, it is necessary to increase the width of the black matrix to ensure that the black matrix has a sufficient coverage width for at least part of the transistors, the data lines and the electrode lines below, so as to reduce the electrical light leakage. For example, a spacing between a boundary of an orthographic projection of the black matrix on the base substrate and a boundary of at least part of a corresponding gate line is greater than or equal to 5 microns, thereby ensuring a sufficient shielding effect, and reducing the electrical light leakage.

In the display substrate where the common electrode is on the upper side and the pixel electrode is on the lower side, through a design of increasing a wrapping width of the gate line wrapping an active layer in the corresponding transistor, the electrical light leakage may be reduced, the width of the black matrix may be reduced, and the leakage current of the transistor of the display substrate may be reduced in an environment of high luminance or high temperature.

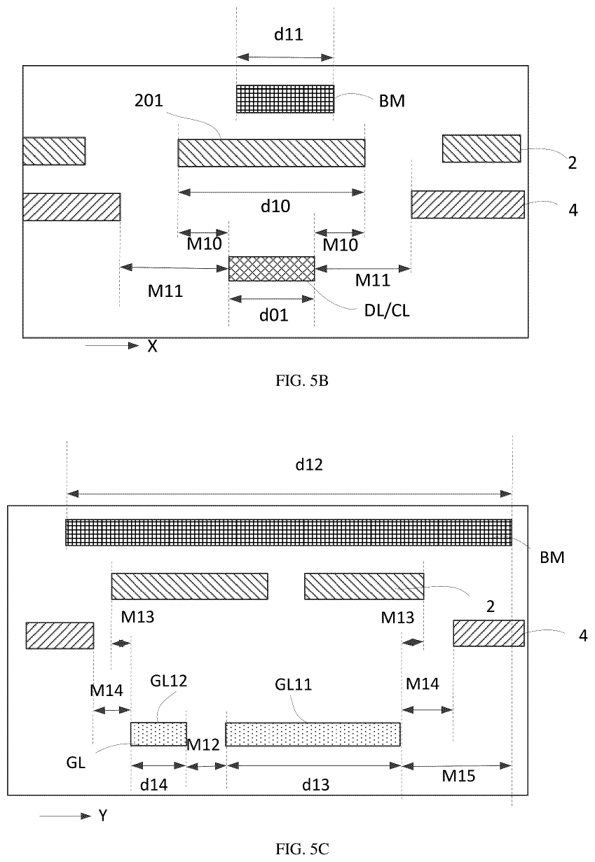

FIG. 5A is a local schematic plan view of a display substrate according to some exemplary embodiments of the present disclosure: FIG. 5B is a schematic cross-sectional view taken along line A1-A1′ in FIG. 5A: FIG. 5C is a schematic cross-sectional view taken along line B1-B1′ in FIG. 5A: FIG. 5D is a local schematic plan view of a display substrate according to some other exemplary embodiments of the present disclosure: FIG. 5E is a schematic cross-sectional view taken along line A2-A2′ in FIG. 5D: FIG. 5F is a schematic cross-sectional view taken along line B2-B2′ in FIG. 5D: FIG. 5G is a local schematic plan view of a display substrate according to some further exemplary embodiments: FIG. 5H is a schematic cross-sectional view taken along line A3-A3′ in FIG. 5G; and FIG. 5I is a schematic cross-sectional view taken along line B3-B3′ in FIG. 5G.

In some display substrates in which the common electrode is on the upper side and the pixel electrode is on the lower side, referring to FIG. 5A to FIG. 5I, an orthographic projection of the active layer on the base substrate falls within the orthographic projection of the gate line on the base substrate, and a spacing m01 between a boundary of the orthographic projection of the gate line on the base substrate and a boundary of an orthographic projection of an adjacent corresponding active layer on the base substrate is approximately 2.75 microns.

Exemplarily, referring to FIG. 5A to FIG. 5C, an included angle between an orthographic projection of the data line DL or the electrode line CL on the base substrate and an orthographic projection of the gate line GL on the base substrate may be approximately 90°. Exemplarily, a width d01 of a portion of the data line DL or the electrode line CL in the first direction X is approximately 2.8 microns. A spacing M11 between one of the data line DL or the electrode line CL and the pixel electrode 4 may be approximately 4.22 microns. The common electrode 2 includes a common electrode first sub-portion 201 of which a projection overlaps with the projection of the data line DL or the electrode line CL, and a width d10 of an orthographic projection of the common electrode first sub-portion 201 on the base substrate in the first direction is approximately 7.4 microns. A protruding distance M10 of the common electrode first sub-portion 201 relative to one of a corresponding data line DL or a corresponding electrode line CL in the first direction X may be approximately 2.55 microns. By increasing a width of the common electrode first sub-portion in the first direction X at an overpass position, the yield may be improved. With continued reference to FIG. 5A to FIG. 5C, the display substrate further includes a black matrix BM. When setting a width of the black matrix B, the cell alignment precision and the light leakage need to be taken into account. In order to ensure a sufficient light shielding effect of the black matrix, an orthographic projection of the black matrix on the base substrate needs to cover at least part of the data line, the electrode line and the gate line. For example, a width d11 of the orthographic projection of the black matrix BM on the base substrate in the first direction is approximately 4.5 microns, and a width d12 thereof in the second direction is approximately 28.1 microns.

Exemplarily, the gate line GL includes a widening portion GL11 and a connecting portion GL12, a width d13 of the widening portion GL11 in the second direction Y is approximately 9.1 microns, and a width d14 of the connecting portion GL12 in the second direction Y is approximately 3 microns. Exemplarily, the minimum spacing M12 between two adjacent gate lines in the second direction Y is greater than or equal to 4 microns. A protruding distance M13 of the common electrode 2 relative to the corresponding gate line in the second direction Y is approximately 1.55 microns. The spacing M14 between the gate line and the corresponding pixel electrode in the second direction is approximately 2.4 microns. The protruding distance M15 of the black matrix BM relative to the widening portion GL11 of a corresponding gate line in the second direction is approximately 5 microns. Through the above design, the aperture ratio of the display panel may reach approximately 44.8%.

Exemplarily, referring to FIG. 5D to FIG. 5F, the included angle between the orthographic projection of the data line DL or the electrode line CL on the base substrate and the orthographic projection of the gate line GL on the base substrate may be greater than 90° or less than 90°. The pixel electrode may be substantially parallel to the data line DL. The spacing M11 between one of the data line DL or the electrode line CL and the pixel electrode 4 may be between 3.5 microns and 4.22 microns. The common electrode 2 includes a common electrode first sub-portion 201 of which a projection overlaps with the projection of the data line DL or the electrode line CL, and the width d10 of the orthographic projection of the common electrode first sub-portion 201 on the base substrate in the first direction is approximately 6.9 microns. The protruding distance M10 of the common electrode first sub-portion 201 relative to one of a corresponding data line DL or a corresponding electrode line CL in the first direction X may be approximately 2.48 microns. Exemplarily, in order to ensure a sufficient light shielding effect of the black matrix, the width d11 of the orthographic projection of the black matrix BM on the base substrate in the first direction is approximately 4.5 microns, and the width d12 thereof in the second direction is approximately 28.1 microns.

Exemplarily, the gate line GL includes a widening portion GL11 and a connecting portion GL12, a width d13 of the widening portion GL11 in the second direction Y is approximately 9.1 microns, and a width d14 of the connecting portion GL12 in the second direction Y is approximately 3 microns. Exemplarily, the minimum spacing M12 between two adjacent gate lines in the second direction Y is greater than or equal to 4 microns. A protruding distance M13 of the common electrode 2 relative to a corresponding gate line in the second direction Y is approximately 1.55 microns. A spacing M14 between the gate line and a corresponding pixel electrode in the second direction is approximately 2.4 microns. A protruding distance M15 of the black matrix BM relative to the widening portion GL11 of a corresponding gate line in the second direction is approximately 5 microns. Through the above design, the aperture ratio of the display panel may be between 43.4% and 44.6%.

Exemplarily, the wrapping width of the gate line wrapping the active layer may be reduced to increase the aperture ratio of the display substrate.

For a display substrate with lower resolution requirements, a wiring space between a data line DL and an electrode line CL adjacent to each other may be increased. For example, referring to FIG. 5G to FIG. 5I, the spacing between the data line DL and the electrode line CL adjacent to each other may be increased to improve the aperture ratio. Exemplarily, a spacing M11 between one of the data line DL or the electrode line CL and the pixel electrode may be approximately 4.5 microns. The common electrode includes a common electrode first sub-portion 201 of which a projection overlaps with the projection of the data line DL or the electrode line CL, and a width d10 of the orthographic projection of the common electrode first sub-portion 201 on the base substrate in the first direction is approximately 6.9 microns. A protruding distance M10 of the common electrode first sub-portion 201 relative to one of a corresponding data line DL or a corresponding electrode line CL in the first direction X may be approximately 3.4 microns. Exemplarily, in order to ensure a sufficient light shielding effect of the black matrix, a width d11 of the orthographic projection of the black matrix BM on the base substrate in the first direction is approximately 4.5 microns, and a width d12 thereof in the second direction is approximately 28.1 microns.

Exemplarily, the gate line GL includes a widening portion GL11 and a connecting portion GL12, a width d13 of the widening portion GL11 in the second direction Y is approximately 9.1 microns, and a width d14 of the connecting portion GL12 in the second direction Y is approximately 3 microns. Exemplarily, the minimum spacing M12 between two adjacent gate lines in the second direction Y is greater than or equal to 4 microns. A protruding distance M13 of the common electrode 2 relative to a corresponding gate line in the second direction Y is approximately 1.55 microns. A spacing M14 between the gate line and a corresponding pixel electrode in the second direction is approximately 2.4 microns. A protruding distance M15 of the black matrix BM relative to the widening portion GL11 of a corresponding gate line in the second direction is approximately 5 microns. Through the above design, the aperture ratio of the display panel may be approximately 46.5%.

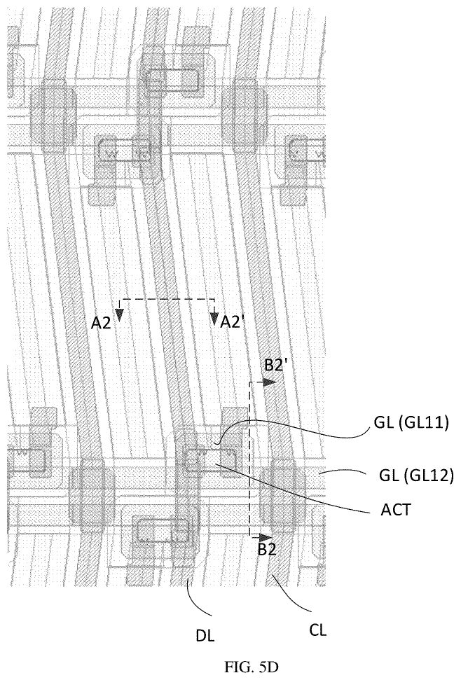

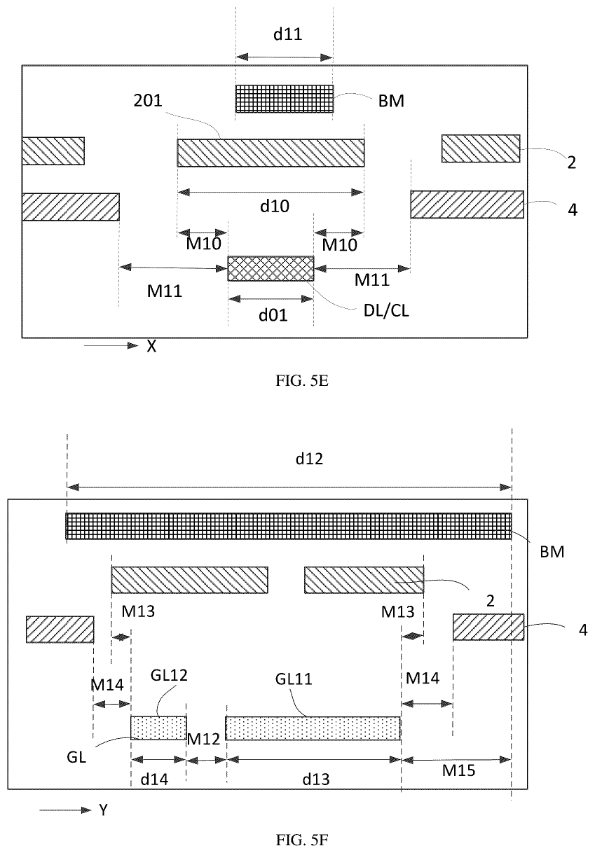

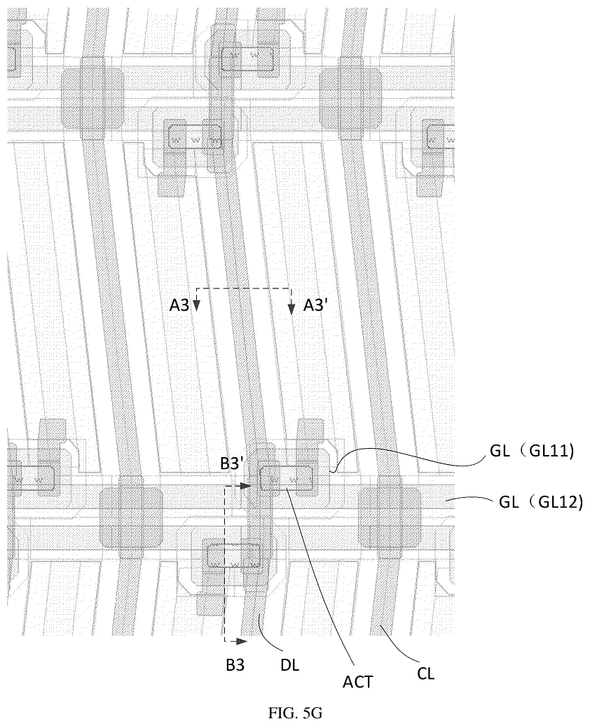

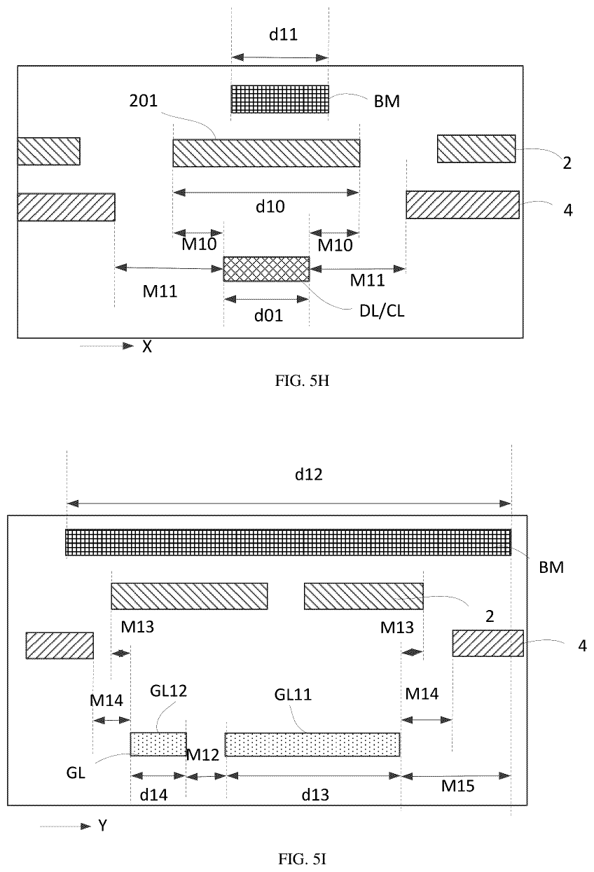

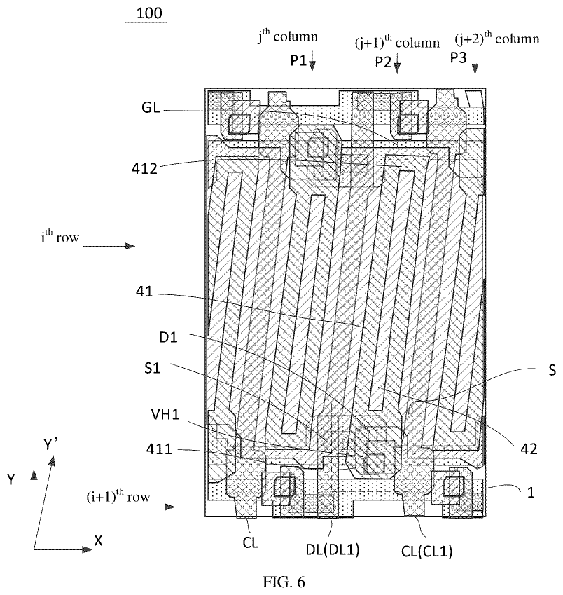

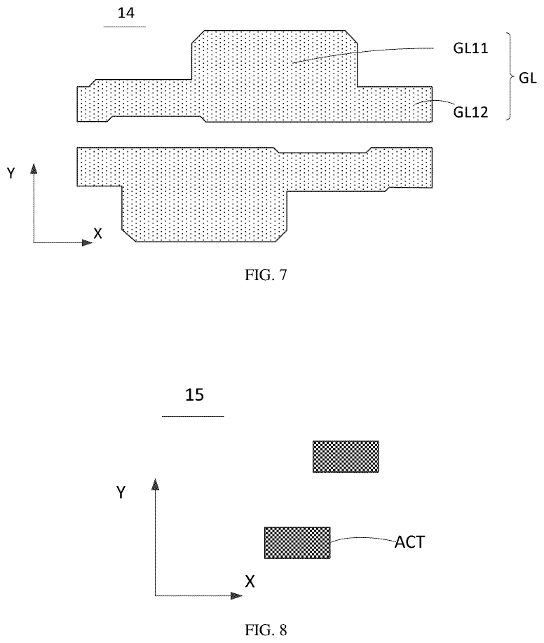

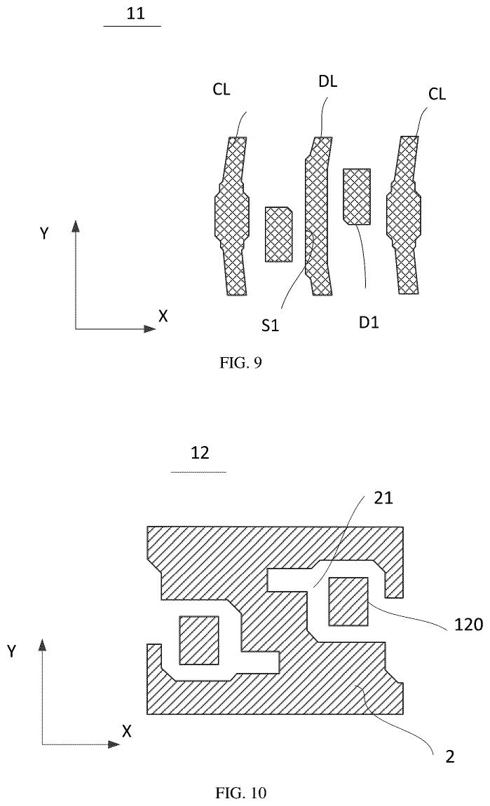

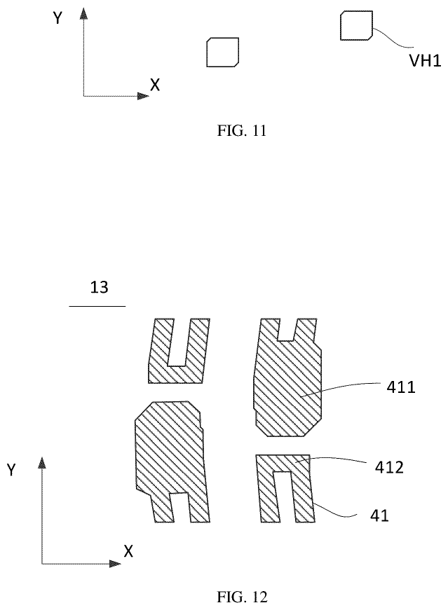

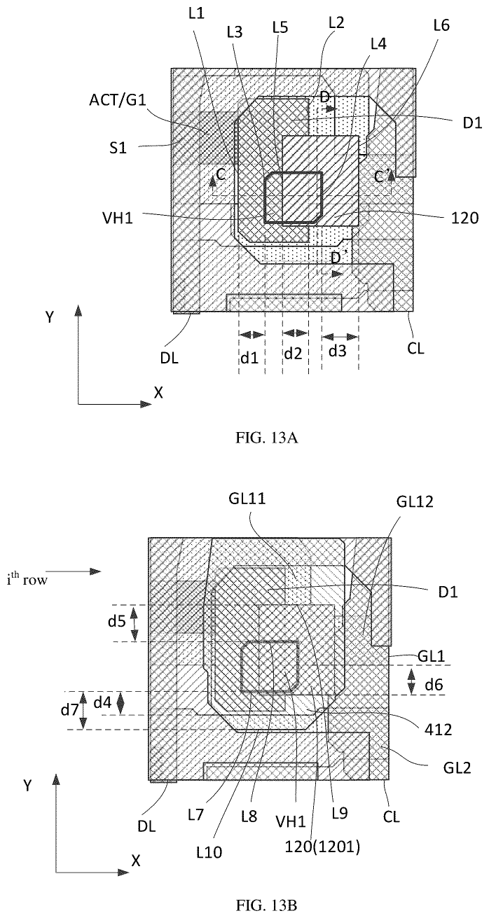

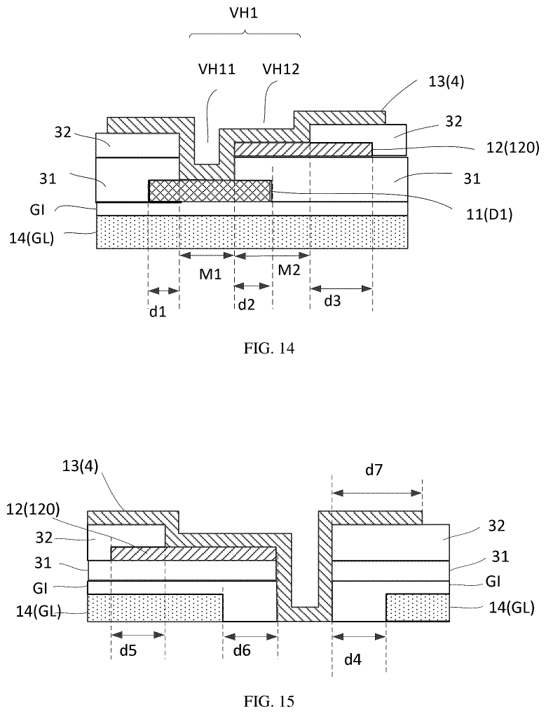

FIG. 6 is a local schematic plan view of a display substrate according to some exemplary embodiments of the present disclosure: FIG. 7 is a local schematic plan view of a fourth conductive layer in FIG. 6; FIG. 8 is a local schematic plan view of a third insulating layer in FIG. 6: FIG. 9 is a local schematic plan view of a first conductive layer in FIG. 6; FIG. 10 is a local schematic plan view of a second conductive layer in FIG. 6: FIG. 11 shows a plurality of via holes in FIG. 6: FIG. 12 is a local schematic plan view of a third conductive layer in FIG. 6: FIG. 13A and FIG. 13B are each a local enlarged schematic diagram of the dotted line area S in FIG. 6: FIG. 14 is a schematic cross-sectional view taken along line CC′ in FIG. 13A; and FIG. 15 is a schematic cross-sectional view taken along line DD′ in FIG. 13A.

Exemplarily, referring to FIG. 6, the pixel electrode further includes a first connecting portion 411 and a second connecting portion 412. The first connecting portion 411 is located at one side of a plurality of pixel electrode strips 41 and is connected to each of the plurality of pixel electrode strips 41. The second connection portion 412 is located at the other side of the plurality of pixel electrode strips 41 and is connected to each of the plurality of pixel electrode strips. The plurality of pixel electrode strips 41 may include two pixel electrode strips, three pixel electrode strips or more pixel electrode strips. FIG. 6 shows a display substrate in which the plurality of pixel electrode strips include two pixel electrode strips. In some embodiments, the plurality of pixel electrode strips may extend in a third direction Y′. There is a predetermined inclined angle between the third direction Y′ and the second direction Y. For example, the plurality of pixel electrode strips 41 may be substantially parallel to the data line DL. In the above display substrate, the planar common electrode 2 and the comb-shaped pixel electrode 4 are stacked on the base substrate of the display substrate. An electric field generated between edges of the comb-shaped pixel electrodes in the same plane and an electric field generated between the comb-shaped pixel electrode layer and the planar common electrode layer form a multi-dimensional electric field, so that all oriented liquid crystal molecules between the comb-shaped pixel electrodes and directly above the pixel electrodes in the liquid crystal cell is capable of rotating, thereby achieving the display of various gray levels.

For example, each subpixel P of the display substrate may further include a thin film transistor located on the base substrate 1. The thin film transistor may include a gate, a first electrode and a second electrode. For example, the first electrode may be one of a source electrode and a drain electrode, and the second electrode may be the other of the source electrode and the drain electrode. The thin film transistor may further include a gate insulating layer and an active layer.

Referring to FIG. 4, in subpixels of the same row, thin film transistors in odd columns of subpixels are connected to the same gate line, such as a first gate line GL1, and thin film transistors in even columns of subpixels are connected to the same gate line, such as a second gate line GL2. In two adjacent columns of subpixels, thin film transistors of the two adjacent columns of subpixels may be connected to the same data line DL. During operation, active signals may be input row by row through the first gate lines GL1 and the second gate lines GL2 to turn on corresponding thin film transistors. Specifically, when a thin film transistor of an odd column in a certain row is turned on, a pixel voltage is input to the thin film transistor of the odd column through a data line DL, and the pixel voltage is transmitted to the pixel electrode to display at a corresponding gray scale. When a thin film transistor of an even column in a certain row is turned on, a pixel voltage is input to the thin film transistor of the even column through a data line DL, and the pixel voltage is transmitted to the pixel electrode to display at a corresponding gray scale. In the dual-gate line driving manner, the number of gate lines is doubled, and the number of data lines is reduced by half, so that the cost of the driver IC may be reduced. Meanwhile, the charging time is reduced to half of that in the single-gate line driving manner, which may affect the charging rate.

As the pixel density of the display substrate increases, the wiring space for thin film transistors gets smaller. For example, in some embodiments, one of the first electrode and the second electrode of the thin film transistor is arranged between a data line DL and an electrode line CL adjacent to each other. For example, referring to FIG. 9, the second electrode D1 of the thin film transistor is arranged between the data line DL and the electrode line CL adjacent to each other. The second electrode of the thin film transistor and the data line DL may be arranged in the same layer, for example, they are both arranged in a first conductive layer. In a pixel driver circuit, the second electrode of the thin film transistor usually needs to be electrically connected to the pixel electrode through a via hole, so as to write a driving signal into the pixel unit. Due to the reduction in the wiring space for thin film transistors, a width of the metal conductive portion where the second electrode D1 of the thin film transistor is located in the first direction X is reduced accordingly. However, due to the limitation of process accuracy, such as the alignment accuracy and the etching accuracy, a certain margin (a via hole spacing) needs to be left in the area where a via hole is formed, so as to avoid a poor display caused by a connection of the pixel electrode and the gate line, which results from the via hole penetrating the insulating layer beneath the first conductive layer due to a deviation in etching the via hole.

The embodiments of the present disclosure provide a display substrate employing a half-via hole connection, in which a protective electrode block is arranged in a via hole region, so that the protective electrode block may be used to protect the via hole in the etching process, so as to prevent the insulating layer beneath the first conductive layer from being etched through during the formation of the via hole, and thereby avoiding the connection between the pixel electrode and the gate line. The protective electrode block may be arranged in a different layer from the second electrode of the thin film transistor, so that the space may be fully utilized in the vertical direction to achieve high-resolution display.

Exemplarily, the protective electrode block may be arranged in the same layer as the common electrode, without arranging in an additional layer, which is conducive to simplifying the process.

Exemplarily, referring to FIG. 10, the protective electrode block 120 and the common electrode 2 may be spaced apart from each other. For example, the protective electrode block 120 may be partially surrounded by the common electrode 2.

Exemplarily, the protective electrode block 120 may be directly connected to no signal line. For example, the protective electrode block is directly connected to the pixel electrode, and the pixel electrode is connected to another signal line. Exemplarily, referring to FIG. 6 to FIG. 15, the display substrate 100 may include a base substrate 1 and a first conductive layer 11 on a side of the base substrate. The first conductive layer 11 includes a plurality of data lines DL and electrode lines CL alternately arranged in a first direction X, the data lines DL and electrode lines CL each extend substantially in the second direction Y, and each column of subpixels is located between the data line DL and the electrode line CL adjacent to each other. The first conductive layer 11 may further include a first electrode S1 and a second electrode D1 of a thin film transistor. For example, a portion of the data line DL may be connected to a first electrode region of the thin film transistor to form the first electrode S1, and the second electrode D1 of the thin film transistor is located between the data line DL and the electrode line CL adjacent to each other.

The display substrate may further include a first insulating layer 31 on a side of the first conductive layer 11 away from the base substrate 1, and a second conductive layer 12 on a side of the first insulating layer 31 away from the base substrate 1. The second conductive layer 12 may include a common electrode 2 and a plurality of protective electrode blocks 120. The common electrode 2 may include a plurality of openings 21. An orthographic projection of at least one of the protective electrode blocks 120 on the base substrate falls within an orthographic projection of at least one of the openings 21 of the common electrode 2 on the base substrate.

The display substrate may further include a second insulating layer 32 on a side of the second conductive layer 12 away from the base substrate, and a third conductive layer 13 on a side of the second insulating layer 32 away from the base substrate. The third conductive layer 13 includes a plurality of pixel electrodes 4, for example, a region where each subpixel is located is provided with a respective pixel electrode 4. Exemplarily, the pixel electrode 4 may be connected to the protective electrode block 120 through a first via hole VH1. The pixel electrode 4 may also be connected to the second electrode D1 of the thin film transistor through the first via hole VH1, thereby achieving a half-via hole connection between the pixel electrode 4 and the second electrode D1 of the thin film transistor. For example, referring to FIG. 13A, an orthographic projection of the second electrode D1 of the thin film transistor on the base substrate at least partially overlaps with an orthographic projection of the protective electrode block 120 on the base substrate. An overlap between the orthographic projection of the second electrode D1 of the thin film transistor on the base substrate and the orthographic projection of the protective electrode block 120 on the base substrate at least partially overlaps with an orthographic projection of the first via hole VH1 on the base substrate. The protective electrode block is arranged near the second electrode D1 of the thin film transistor, and the protective electrode block may be a transparent conductive layer, such as an ITO layer. During the formation of the first via hole, the protective electrode block may block an etching to the layer beneath the protective electrode block during the etching process, so that both of the second electrode D1 of the thin film transistor and the protective electrode block 120 may be used to achieve a sufficient via hole spacing. Since the second electrode D1 of the thin film transistor and the protective electrode block 120 are located in different layers, a sufficient via hole spacing may be ensured without increasing the width of the second electrode D1 of the thin film transistor, so that it is possible to prevent the layer beneath the second electrode D1 of the thin film transistor from being penetrated during the etching of the via hole, thereby reducing the probability of a short circuit between the pixel electrode and the gate line, which is beneficial to improving the yield of the display substrate.

Exemplarily, referring to FIG. 14, the first via hole VH1 may include a first sub-via hole VH11 and a second sub-via hole VH12. The first sub-via hole VH11 and the second sub-via hole VH12 are adjacent and connected to each other in the first direction X. The first sub-via hole VH1 penetrates the first insulating layer 31 and the second insulating layer 32, and the pixel electrode 4 is connected to the second electrode D1 of the thin film transistor through the first sub-via hole VH11. The second sub-via hole VH2 penetrates the second insulating layer 32, and the pixel electrode 4 is connected to the protective electrode block 120 through the second sub-via hole VH2. The first via hole VH adopts a half via hole connection manner, in which a portion of the first via hole VH1 is located above the protective electrode block, so that the etching of the portion of the first via hole is stopped in the protective electrode block region during the formation of the via hole. For example, a specific via hole etching process may be adopted, and an etching process that is capable of etching the insulating layer but is not capable of etching ITO may be selected. In this way, in the formation process of the first via hole, the first sub-via hole VH11 penetrating the first insulating layer 31 and the second insulating layer 32 and the second sub-via hole VH12 penetrating the second insulating layer 32 may be formed. It is possible to ensure that the pixel electrode 4 is electrically connected to the second electrode D1 of the thin film transistor through the first sub-via hole VH11. The protective electrode block 120 stops the etching of the second sub-via hole VH12 at a surface of the protective electrode block away from the base substrate. In this way, it is possible to prevent poor display caused by an electrical connection between the gate line GL beneath the second electrode D1 of the thin film transistor and the pixel electrode, which results from the insulating layer GI beneath the second electrode D1 of the thin film transistor being etched through due to factors such as alignment accuracy deviation or etching accuracy deviation during the formation of the first via hole VH1.

Exemplarily, in some embodiments of the present disclosure, referring to FIG. 14, the first sub-via hole VH11 has a first width M1 in the first direction, and the second sub-via hole VH12 has a second width M2 in the first direction, and the first width M1 is smaller than the second width M2. In a limited wiring space, the first sub-via hole VH11 is configured to have a smaller first width in the first direction, so that the second electrode D1 of the thin film transistor may be ensured to provide a sufficient via hole spacing, thereby preventing the first via hole from being beyond an edge of the second electrode D1 of the thin film transistor and penetrating the insulating layer beneath the second electrode D1 of the thin film transistor due to process deviations.

Exemplarily, in some embodiments of the present disclosure, referring to FIG. 13A, the orthographic projection of the second electrode D1 of the thin film transistor on the base substrate includes a first side edge L1 and a second side edge L2 extending in the second direction Y. The orthographic projection of the first via hole VH1 on the base substrate includes a third side edge L3 and a fourth side edge L4 extending in the second direction Y. The orthographic projection of the protective electrode block 120 on the base substrate includes a fifth side edge L5 and a sixth side edge L6 extending in the second direction Y. The first side edge L1, the third side edge L3, the fifth side edge L5, the second side edge L2, the fourth side edge L4 and the sixth side edge L6 are sequentially arranged at intervals in the first direction X. In order to ensure that in the half via hole connection structure, the second electrode D1 of the thin film transistor and the protective electrode block 120 beneath the first via hole VH1 provide a sufficient via hole spacing, a distance between the first side edge L1 and the third side edge L3 is set to be a first preset distance d1, for example, the first preset distance d1 may be greater than or equal to 9.6 μm. Through the large via hole spacing between the first side edge L1 of the second electrode D1 of the thin film transistor and the third side edge L3 of the first via hole VH1, it may be ensured that in the case of the presence of process errors such as etching deviation or alignment deviation, an orthographic projection of the third side edge L3 of the first via hole on the base substrate may still fall within the orthographic projection of the second electrode D1 of the thin film transistor on the base substrate, thereby preventing the connection between the pixel electrode and the gate line caused by the insulating layer beneath the second electrode D1 of the thin film transistor being penetrated by the first via hole.

Exemplarily, in some embodiments of the present disclosure, with continued reference to FIG. 13A, a distance between the fifth side edge L5 and the second side edge L2 is set to be a second preset distance d2. In the first direction X, a width of an overlap between the second electrode D1 of the thin film transistor and the protective electrode block is the second preset distance d2. The width of the overlap between the second electrode D1 of the thin film transistor and the protective electrode block 120 is large, so that after the second electrode D1 of the thin film transistor is etched, the protective electrode block 120 is etched and the second electrode D1 of the thin film transistor is aligned with the protective electrode block 120, there is still an overlap between the second electrode D1 of the thin film transistor and the protective electrode block 120. In this way, it is possible to prevent a blank region without the protective electrode block or the second electrode D1 of the thin film transistor from being formed between the second electrode D1 of the thin film transistor and the protective electrode block 120 due to process deviations, so that it is possible to prevent the connection between the pixel electrode and the gate line, which results from the insulating layer beneath the second electrode D1 of the thin film transistor being penetrated by the via hole.

Exemplarily, a distance between the fourth side edge L4 and the sixth side edge L6 is set to be a third preset distance d3. The third preset distance d3 is a via hole spacing corresponding to the protective electrode block. Through the large via hole spacing between the sixth side edge L6 of the protective electrode block 120 and the fourth side edge L4 of the first via hole VH1, it may be ensured that an orthographic projection of the fourth side edge L4 of the first via hole on the base substrate falls within the orthographic projection of the protective electrode block 120 on the base substrate, so that the portion of the first via hole over the protective electrode block may only penetrate the second insulating layer 32, thereby preventing the connection between the pixel electrode and the gate line resulting from the insulating layer beneath the second electrode D1 of the thin film transistor being penetrated by the via hole. For example, the third preset distance d3 may be greater than or equal to 9.6 μm.

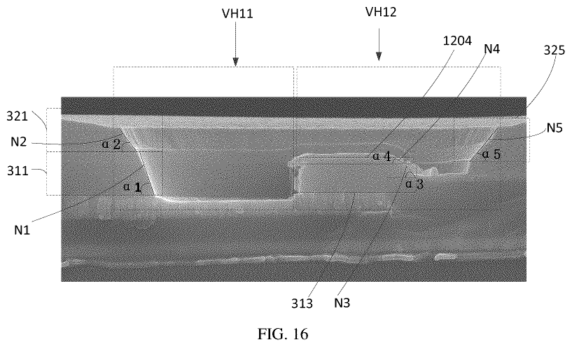

FIG. 16 is a SEM diagram of a display substrate in a first via hole region in a first direction according to some exemplary embodiments of the present disclosure.

Exemplarily, in some embodiments of the present disclosure, referring to FIG. 14 and FIG. 16, the first insulating layer 31 includes a first portion 311 adjacent to the first sub-via hole VH11, and an orthographic projection of the first portion 311 on the base substrate does not overlap with an orthographic projection of the second sub-via hole VH12 on the base substrate. The first portion 311 includes a first side wall N1 close to the first sub-via hole VH11, and the first side wall N1 has a first slope angle α1. The second insulating layer 32 includes a second portion 321 adjacent to the first sub-via hole VH11, and an orthographic projection of the second portion 321 on the base substrate does not overlap with the orthographic projection of the second sub-via hole VH12 on the base substrate. The second portion 321 includes a second side wall N2 close to the first sub-via hole VH11, and the second side wall N2 has a second slope angle α2. The first slope angle α1 is greater than the second slope angle α2. For example, the first slope angle α1 is approximately 67°, and the second slope angle α2 is approximately 42°.

Exemplarily, with continued reference to FIG. 14 and FIG. 16, the first insulating layer 31 further includes a third portion 313 adjacent to the first sub-via hole VH11, an orthographic projection of the third portion 313 on the base substrate falls within the orthographic projection of the second electrode D1 of the thin film transistor on the base substrate, and the orthographic projection of the third portion 313 on the base substrate falls within the orthographic projection of the protection electrode block 120 on the base substrate. The third portion 313 includes a third side wall N3 away from the first sub-via hole VH11, and the third side wall N3 has a third slope angle α3. The protective electrode block 120 includes a fourth portion 1204, and an orthographic projection of the fourth portion 1204 on the base substrate falls within the orthographic projection of the third portion 313 of the first insulating layer on the base substrate. The fourth portion 1204 of the protective electrode block 120 includes a fourth side wall N4 away from the first sub-via hole VH11, and the fourth side wall N4 has a fourth slope angle α4. The third slope angle α3 is greater than the fourth slope angle α4. In some embodiments, the third slope angle α3 may be greater than or equal to twice the fourth slope angle α4. For example, the third slope angle α3 is approximately 52°, and the fourth slope angle is approximately 26°.

Exemplarily, continuing to refer to FIG. 14 and FIG. 16, the second insulating layer 32 further includes a fifth portion 325 adjacent to the second sub-via hole VH12, and an orthographic projection of the fifth portion 325 on the base substrate at least partially overlaps with the orthographic projection of the protective electrode block 120 on the base substrate. The fifth portion 325 includes a fifth sidewall N5 close to the second sub-via hole VH12, and the fifth sidewall N5 has a fifth slope angle α5. The fifth slope angle α5 is greater than or equal to 30°. For example, the fifth slope angle α5 is approximately 38°.

By optimizing the etching process, the inclination angles of part of the side walls of the first insulating layer, the second insulating layer and the protective electrode block may be adjusted in the formation process of the first via hole, so as to ensure that an inclination angle of a side wall of a layer close to the base substrate is greater than an inclination angle of a side wall of a layer away from the base substrate. In this way, in the region where the first via hole is located, a layer close to the base substrate, such as the first insulating layer, may provide support for a layer far away from the base substrate, such as the layer where the protective electrode block is located or the second insulating layer, which is beneficial to improving the etching accuracy of the via hole and reducing the probability of over-etching of the via hole.

Exemplarily, in some embodiments of the present disclosure, referring to FIG. 7, FIG. 8, FIG. 13A, FIG. 13B and FIG. 14, the display substrate may further include: a third insulating layer GI on a side of the first conductive layer 11 close to the base substrate, and the third insulating layer GI may be a gate insulating layer. The display substrate may further include a fourth conductive layer 14 on a side of the third insulating layer GI close to the base substrate and a semiconductor layer 15 between the third insulating layer 33 and the first conductive layer 11. The active layer ACT of the thin film transistor may be located in the semiconductor layer 15. An overlap between the fourth conductive layer 14 and the active layer ACT serves as a gate electrode G1 of the thin film transistor. The fourth conductive layer 14 further includes a gate line GL connected to the gate electrode G1. The gate line GL includes a widening portion GL11 and a connecting portion GL12. The gate electrode G1 is located in the widening portion GL11, and the orthographic projection of the second electrode D1 of the thin film transistor on the base substrate at least partially overlaps with an orthographic projection of the widening portion GL11 on the base substrate. The orthographic projection of the second electrode D1 of the thin film transistor on the base substrate does not overlap with an orthographic projection of the connecting portion GL12 on the base substrate. The projection of the second electrode D1 of the thin film transistor on the base substrate falls within the orthographic projection of the widening portion GL11 on the base substrate, so that it is beneficial to increasing an area of the second electrode D1 of the thin film transistor and an area of the gate electrode G1, so as to improve the transmission performance of the thin film transistor.

Exemplarily, in some embodiments of the present disclosure, referring to FIG. 7, FIG. 8, FIG. 13A, FIG. 13B and FIG. 14, the orthographic projection of the protective electrode block 120 on the base substrate at least partially overlaps with the orthographic projection of the widening portion GL11 on the base substrate. The orthographic projection of the protective electrode block 120 on the base substrate at least partially overlaps with the orthographic projection of the connecting portion GL12 on the base substrate.

Referring to FIG. 6, the first connecting portion 411 is connected to the second electrode D1 of a corresponding thin film transistor through the first via hole VH1, and an orthographic projection of the second connecting portion 412 on the base substrate at least partially overlaps with the orthographic projection of the gate line GL on a corresponding side on the base substrate.

Exemplarily, referring to FIG. 13B and FIG. 15, the first via hole VH1 further includes a seventh side edge L7 extending in the first direction X. For example, the seventh side edge L7 in the i^{th} row of subpixels is located between the first gate line GL1 and the second gate line GL2, and a distance between the seventh side edge L7 and the second gate line GL2 is a fourth preset distance d4. By optimizing the fourth preset distance d4, a distance between the seventh side edge L7 of the first via hole VH1 and the adjacent gate line may be ensured to be large enough, so that the via hole may be prevented from being connected to the adjacent gate line.

The first via hole VH1 further includes an eighth side edge L8 extending in the first direction. An orthographic projection of the eighth side edge L8 on the base substrate falls within the orthographic projection of the gate line on the base substrate. The protective electrode block 120 includes a ninth side edge L9 extending in the first direction. An orthographic projection of the ninth side edge L9 on the base substrate at least partially overlaps with the orthographic projection of the widening portion GL11 of the gate line on the base substrate. A distance d5 between the eighth side edge L8 and the ninth side edge L9 is a fifth preset distance. By designing a via hole spacing corresponding to the protective electrode block in the second direction, it is possible to prevent the via hole from exceeding the range of the protective electrode block, thereby preventing the via hole from being connected to the gate line.

The orthographic projection of the protective electrode block 120 on the base substrate at least partially overlaps with the orthographic projection of the gate line GL on the base substrate. The protective electrode block includes a protruding portion 1201 protruding relative to the gate line in the second direction. The protruding portion 1201 is located between two adjacent gate lines, and the protruding portion 1201 has a first protruding distance d6 in the second direction Y. By configuring the protective electrode block to protrude relative to the gate line in the second direction, a part of a side edge of the gate line is covered by the protective electrode block, so that it is possible to ensured that the via hole is formed on the protective electrode block rather than the gate line, thereby preventing the pixel electrode from being connected to the gate line.

Exemplarily, in some embodiments of the present disclosure, with continued reference to FIG. 13B and FIG. 15, the first connecting portion 411 in the pixel electrode includes a tenth side edge L10 extending in the first direction. A distance between the tenth side edge L10 and the seventh side edge L7 of the first via hole VH1 is a seventh preset distance d7. The seventh preset distance d7 may be a via hole spacing corresponding to the pixel electrode, which may ensure that the pixel electrode covers the via hole and ensure the reliability of the connection between the pixel electrode and the second electrode of the thin film transistor.

Exemplarily, in the embodiments of the present disclosure, referring to FIG. 6, the display substrate may include a first subpixel P1 in the i^{th} row and the j^{th} column, a second subpixel P2 in the i^{th} row and the (j+1)^{th} column, and a third subpixel P3 in the i^{th} row and a (j+2)^{th} column. The second subpixel P2 includes a second subpixel electrode 42. The display substrate further includes a first data line DLI between the j^{th} column of subpixels and the (j+1)^{th} column of subpixels, and a first electrode line CL1 between the (j+1)^{th} column of subpixels and the (j+2)^{th} column of subpixels. An orthographic projection of the second subpixel electrode 42 on the base substrate at least partially overlaps with an orthographic projection of the first electrode line CL1 on the base substrate.

The pixel electrode is arranged in the third conductive layer. By adopting the top pixel design, in the direction perpendicular to the base substrate, the distance between the pixel electrode and the first conductive layer where source and drain electrodes of the thin film transistor are located is large, and the orthographic projection of the pixel electrode on the base substrate may partially overlap with an orthographic projection of at least one of the data line or the electrode line on the base substrate, which is beneficial to increasing a storage capacitance of thin film transistors and optimizing the display effect.

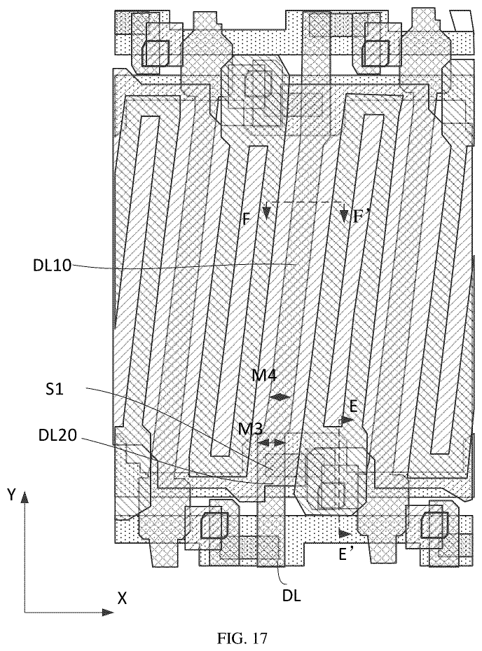

FIG. 17 is a local schematic plan view of a display substrate according to some exemplary embodiments of the present disclosure.

Exemplarily, in some embodiments of the present disclosure, referring to FIG. 17, the data line DL includes a body portion DL10 and a connecting portion DL20. The connecting portion DL20 is connected to the first electrode S1 of the thin film transistor. The connecting portion DL20 extends substantially in the second direction Y, and the connecting portion DL20 may share part of conductive portions with the body DL10. The connecting portion DL20 has a third width M3 in the first direction X, and the body portion DL10 has a fourth width M4 in the first direction X, and the ratio of the third width M3 to the fourth width M4 is between 0.8 and 1.2. In some embodiments, an orthographic projection of the connecting portion DL20 on the base substrate may substantially overlap with an orthographic projection of the body portion DL10 on the base substrate. Such design may reduce the maximum width of the data line in the first direction, and may left more space for wiring the second electrode of the thin film transistor, which is conducive to achieving a high-resolution display design.

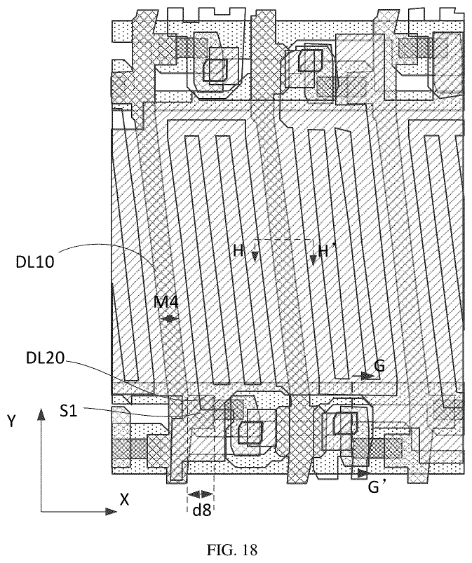

FIG. 18 is a local schematic plan view of a display substrate according to some exemplary embodiments of the present disclosure.

Exemplarily, in some embodiments of the present disclosure, referring to FIG. 18, the wiring space between the data line and the electrode line adjacent to each other is large, thus the data line may be designed in a flexible way. For example, the data line DL includes a body portion DL10 and a connecting portion DL20, and the connecting portion DL20 is connected to the first electrode S1 of the thin film transistor. The connecting portion DL20 protrudes relative to the body portion DL10 by a second protruding distance d8 in the first direction X, the body portion DL10 has a fourth width M4 in the first direction X, and the second protruding distance d8 is greater than the fourth width M4. In a display substrate with a low resolution, the wiring space between the data line and the electrode line is large. By designing the connecting portion of the data line as a structure protruding in the first direction, the wiring space may be fully utilized and the reliability of data transmission may be improved.

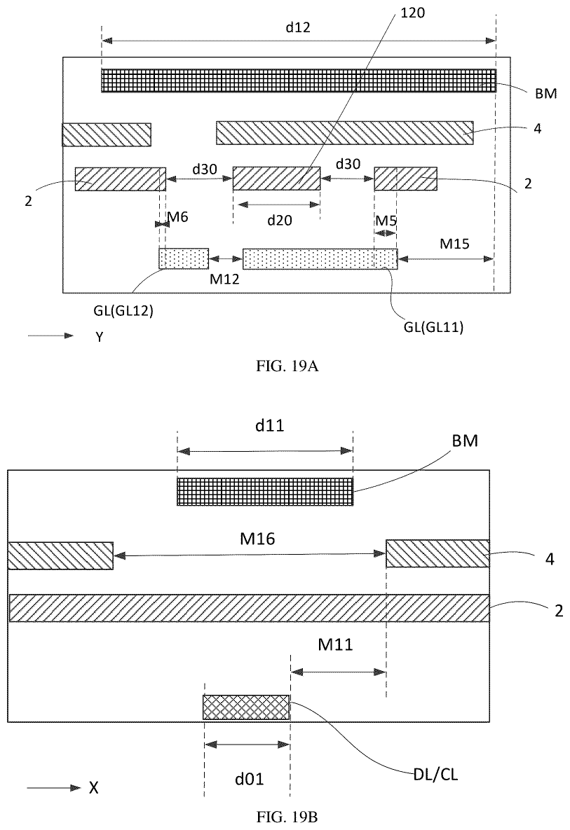

FIG. 19A is a schematic cross-sectional view of a display substrate provided according to some embodiments of the present disclosure taken along line EE′ in FIG. 17: FIG. 19B is a schematic cross-sectional view of a display substrate provided according to some embodiments of the present disclosure taken along line FF′ in FIG. 17: FIG. 19C is a schematic cross-sectional view of a display substrate provided according to some embodiments of the present disclosure taken along line GG′ in FIG. 18; and FIG. 19. D is a schematic cross-sectional view of a display substrate provided according to some embodiments of the present disclosure taken along line HH′ in FIG. 18.

Exemplarily, in some embodiments of the present disclosure, referring to FIG. 6, FIG. 7, FIG. 10, FIG. 13B and FIG. 19A to FIG. 19D, the orthographic projection of the common electrode 2 on the base substrate at least partially overlaps with the orthographic projection of the gate line GL on the base substrate. For example, the display substrate includes a plurality of gate lines GL extending in the first direction X. The gate line GL is located between two adjacent rows of subpixel regions, and the gate line includes a widening portion GL11 and a connecting portion GL12. Two gate lines are arranged between every two adjacent rows of subpixel regions. For example, a plurality of subpixels include a plurality of rows of subpixels respectively located in the i^{th} row and the (i+1)^{th} row, where i is greater than or equal to 1. The gate line includes a first gate line GL1 and a second gate line GL2 which are located between a region where the i^{th} row of subpixels is located and a region where the (i+1)^{th} row of subpixels is located. The orthographic projection of the common electrode 2 on the base substrate at least partially overlaps with the orthographic projection of the widening portion GL11 of the first gate line GL1 on the base substrate. Exemplarily, an overlap between the orthographic projection of the common electrode 2 and the orthographic projection of the widening portion GL11 of the first gate line GL1 has a first overlapping width M5 in the second direction Y, and the first overlapping width M5 is greater than or equal to 0.85 microns.

Exemplarily, the orthographic projection of the common electrode 2 on the base substrate at least partially overlaps with the orthographic projection of the connecting portion GL12 of the second gate line GL2 on the base substrate. An overlap between the orthographic projection of the common electrode 2 and the orthographic projection of the connecting portion GL12 of the second gate line GL2 has a second overlapping width M6 in the second direction Y, and the second overlapping width M6 is greater than or equal to 0.5 microns. Since the common electrode is located on the side of the pixel electrode close to the base substrate, a spacing between the common electrode and each of the transistor, the gate line, the data line and the electrode line below along the light output direction is small, and a potential at the common electrode has a good shielding effect on the signal fluctuation in the elements such as the transistor, the gate line, the data line and the electrode line. Since the potential at the common electrode may shield the influence of the signal in the gate line on the pixel unit, the larger the overlap between the common electrode and the gate line is, the more significant the shielding effect of the common electrode will be, and the more compactly the wires in the second direction may be arranged. The display substrate further includes a black matrix BM, and for a width of the black matrix BM, the cell alignment precision and the light leakage needs to be taken into account. The better the shielding of the common electrode on the gate line signal, the smaller a width of the pixel driver circuit in the second direction will be, and accordingly, the smaller the width of the black matrix BM will be. In this way, an area occupied by the non-light-transmitting region in the display substrate may be reduced, which is conducive to improving the aperture ratio of the display substrate and improving the display effect of the display substrate. For example, the spacing M15 between a boundary of the orthographic projection of the black matrix on the base substrate and a boundary of at least part of the corresponding gate line is approximately 3.9 microns, so as to ensure a sufficient shielding effect and reduce the electrical light leakage. Compared with 5 microns in the above embodiments, the spacing between the boundary of the black matrix and the boundary of the corresponding gate line may be reduced, for example, the spacing is reduced from 5 microns to 3.9 microns, so that the overall width of the black matrix may be reduced, which is conducive to increasing the aperture ratio of the display panel.

Exemplarily, referring to FIG. 17, FIG. 19A and FIG. 19B, a width d01 of part of the data line DL or the electrode line CL in the first direction is approximately 2.8 microns. The spacing M12 between adjacent gate lines in the second direction Y is approximately 4 microns. The spacing M16 between adjacent pixel electrodes 4 in the first direction is approximately 9.36 microns. The spacing M11 between one of the data line DL or the electrode line CL and the pixel electrode 4 may be approximately 3.28 microns. A width d20 of the orthographic projection of the protective electrode block 120 on the base substrate in the second direction Y is approximately 5.75 microns. The spacing d30 between the protective electrode block 120 and the adjacent common electrode 2 in the second direction Y is approximately 4 microns. Exemplarily, in order to ensure a sufficient shading effect of the black matrix, the width d11 of the orthographic projection of the black matrix BM on the base substrate in the first direction is approximately 4.5 microns, and the width d12 in the second direction is approximately 25.1 microns. By optimizing the pixel arrangement and reducing the width of the black matrix, the aperture ratio of the display panel in the exemplary embodiments of the present disclosure may be in a range of 45.9% to 47.3%.

Compared with a display substrate in which the pixel electrode is on the lower side and the common electrode is on the upper side, when the pixel density is the same, in the display substrate according to the embodiments of the present disclosure in which the pixel electrode is at the top, the common electrode is at the bottom and the protective electrode block is provided, the width of the black matrix BM in the second direction may be reduced, for example, the width is reduced from 28.1 microns to 25.1 microns, thereby increasing the aperture ratio of the display panel and improving the display effect. For example, the aperture ratio is increased from 44.6% to 47.3%.

In some display substrates with a low pixel density, the wiring space between a data line and an electrode line adjacent to each other is large, and by optimizing the pixel wiring design, the aperture ratio of the display panel may be further increased.

Exemplarily, referring to FIG. 19C and FIG. 19D, the spacing M11 between one of the data line DL or the electrode line CL and the pixel electrode may be approximately 3.21 microns. The width d20 of the orthographic projection of the protective electrode block 120 on the base substrate in the second direction Y is approximately 6.45 microns. The spacing d30 between the protective electrode block 120 and the adjacent common electrode 2 in the second direction Y is approximately 3.8 microns. Exemplarily, in order to ensure a sufficient light shielding effect of the black matrix, the width d11 of the orthographic projection of the black matrix BM on the base substrate in the first direction is approximately 4.5 microns, and the width d12 in the second direction is approximately 25.1 microns. By optimizing the pixel arrangement and reducing the width of the black matrix, the aperture ratio of the display panel in the exemplary embodiments of the present disclosure may reach 54.5%.

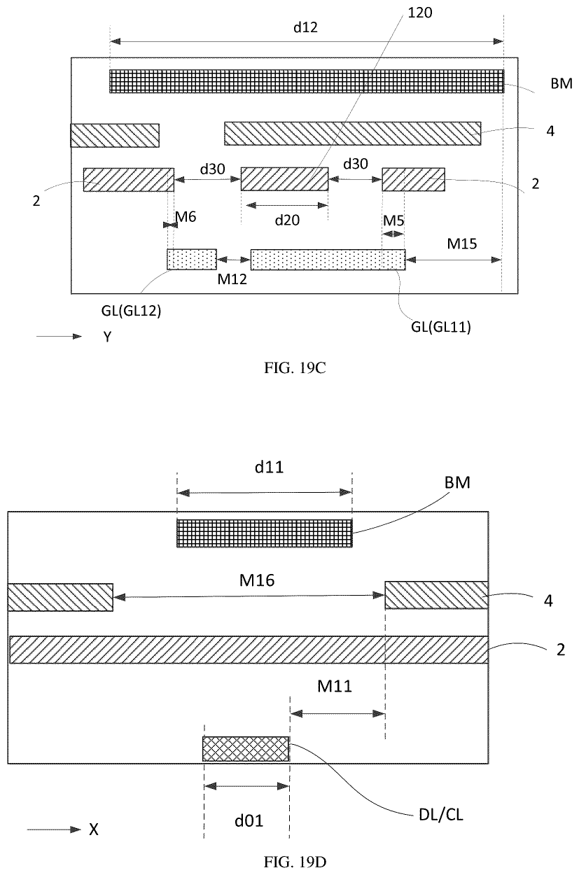

Compared with the display substrate in which the pixel electrode is on the lower side and the common electrode is on the upper side, when the pixel density is the same, in the display substrate according to the embodiments of the present disclosure in which the pixel electrode is on the upper side, the common electrode is on the lower side, and the protective electrode block is provided, the width of the black matrix BM in the second direction may be reduced, for example, the width is reduced from 28.1 microns to 25.1 microns, thereby increasing the aperture ratio of the display panel and improving the display effect. For example, the aperture ratio is increased from 46.5% to 54.5%. FIG. 20 is a schematic structural diagram of a display apparatus provided according to some embodiments of the present disclosure.

Optionally, the embodiments of the present disclosure further provide a display panel. Referring to FIG. 20, the display panel 200 may include the above display substrate 100.

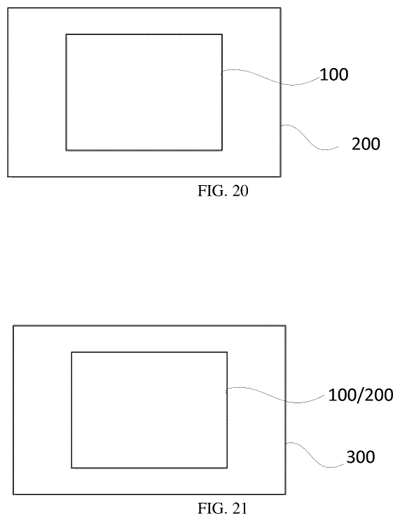

FIG. 21 is a schematic structural diagram of a display apparatus provided according to some embodiments of the present disclosure.

Optionally, the embodiments of the present disclosure further provide a display apparatus. Referring to FIG. 21, the display apparatus 300 may include the above display substrate 100 or the above display panel 200. The display apparatus may include, but is not limited to, any product or component with a display function, such as electronic paper, a mobile phone, a tablet computer, a display, a notebook computer, a digital photo frame, and a navigator. It should be understood that the display apparatus has the same beneficial effects as the display substrate provided in the foregoing embodiments.

Although some embodiments of the general inventive concept of the present disclosure have been shown and described, it will be understood by those skilled in the art that changes may be made to these embodiments without departing from the principles and spirits of the general inventive concept of the present disclosure, and the scope of the present disclosure is defined by the claims and equivalents thereof.

1. A display substrate, comprising a plurality of subpixels arranged in an array in a first direction and a second direction interesting the first direction, wherein
the display substrate comprises:
a base substrate;
a first conductive layer on a side of the base substrate, wherein the first conductive layer comprises a plurality of data lines and a plurality of electrode lines alternately arranged in the first direction, the data lines and the electrode lines each extend in the second direction, and each column of subpixels is located between a data line and an electrode line adjacent to each other; and the first conductive layer further comprises a first electrode and a second electrode of a thin film transistor, the data line is connected to the first electrode of the thin film transistor, and the second electrode of the thin film transistor is located between the data line and the electrode line adjacent to each other;
a first insulating layer on a side of the first conductive layer away from the base substrate;
a second conductive layer on a side of the first insulating layer away from the base substrate, wherein the second conductive layer comprises a common electrode and a plurality of protective electrode blocks, the common electrode comprises a plurality of openings, and an orthographic projection of at least one of the protective electrode blocks on the base substrate falls within an orthographic projection of at least one of the openings of the common electrode on the base substrate;
a second insulating layer on a side of the second conductive layer away from the base substrate; and
a third conductive layer on a side of the second insulating layer away from the base substrate, wherein the third conductive layer comprises a plurality of pixel electrodes, a region where each subpixel is located is provided with a respective one of the pixel electrodes, the pixel electrode is connected to the protective electrode block through a first via hole, and the pixel electrode is connected to the second electrode of the thin film transistor through the first via hole,
wherein an orthographic projection of the second electrode of the thin film transistor on the base substrate at least partially overlaps with the orthographic projection of the protective electrode block on the base substrate; and
an overlap between the orthographic projection of the second electrode of the thin film transistor on the base substrate and the orthographic projection of the protective electrode block on the base substrate at least partially overlaps with an orthographic projection of the first via hole on the base substrate.

2. The display substrate according to claim 1, wherein the first via hole comprises a first sub-via hole and a second sub-via hole, wherein the first sub-via hole and the second sub-via hole are adjacent and connected to each other in the first direction;
the first sub-via hole penetrates the first insulating layer and the second insulating layer, and the pixel electrode is connected to the second electrode of the thin film transistor through the first sub-via hole; and
the second sub-via hole penetrates the second insulating layer, and the pixel electrode is connected to the protective electrode block through the second sub-via hole.

3. The display substrate according to claim 2, wherein the first sub-via hole has a first width in the first direction, and the second sub-via hole has a second width in the first direction, and the first width is smaller than the second width.

4. The display substrate according to claim 1, wherein the orthographic projection of the second electrode of the thin film transistor on the base substrate includes a first side edge and a second side edge each extending in the second direction;
the orthographic projection of the first via hole on the base substrate includes a third side edge and a fourth side edge each extending in the second direction, and
the orthographic projection of the protective electrode block on the base substrate includes a fifth side edge and a sixth side edge each extending in the second direction,
wherein the first side edge, the third side edge, the fifth side edge, the second side edge, the fourth side edge and the sixth side edge are sequentially arranged at intervals in the first direction.

5. The display substrate according to claim 4, wherein a distance between the first side edge and the third side edge is a first preset distance.

6. The display substrate according to claim 4, wherein a distance between the fifth side edge and the second side edge is a second preset distance.

7. The display substrate according to claim 4, wherein a distance between the fourth side edge and the sixth side edge is a third preset distance.

8. The display substrate according to claim 2, wherein the first insulating layer comprises a first portion adjacent to the first sub-via hole, and an orthographic projection of the first portion on the base substrate does not overlap with an orthographic projection of the second sub-via hole on the base substrate, wherein the first portion comprises a first sidewall close to the first sub-via hole, and the first sidewall has a first slope angle; and
the second insulating layer comprises a second portion adjacent to the first sub-via hole, and an orthographic projection of the second portion on the base substrate does not overlap with the orthographic projection of the second sub-via hole on the base substrate, wherein the second portion comprises a second sidewall close to the first sub-via hole, and the second sidewall has a second slope angle,
wherein the first slope angle is greater than the second slope angle.

9. The display substrate according to claim 8, wherein the first insulating layer further comprises a third portion adjacent to the first sub-via hole, an orthographic projection of the third portion on the base substrate falls within the orthographic projection of the second electrode of the thin film transistor on the base substrate, and the orthographic projection of the third portion on the base substrate falls within the orthographic projection of the protective electrode block on the base substrate, wherein the third portion comprises a third sidewall away from the first sub-via hole, and the third sidewall has a third slope angle; and
the protective electrode block comprises a fourth portion, and an orthographic projection of the fourth portion on the base substrate falls within the orthographic projection of the third portion of the first insulating layer on the base substrate, wherein the fourth portion of the protective electrode block comprises a fourth sidewall away from the first sub-via hole, and the fourth sidewall has a fourth slope angle,
wherein the third slope angle is greater than or equal to twice the fourth slope angle.

10. The display substrate according to claim 9, wherein the second insulating layer further comprises a fifth portion adjacent to the second sub-via hole, an orthographic projection of the fifth portion on the base substrate at least partially overlaps with the orthographic projection of the protective electrode block on the base substrate, wherein the fifth portion comprises a fifth sidewall close to the second sub-via hole, the fifth sidewall has a fifth slope angle, and the fifth slope angle is greater than or equal to 30°.

11. The display substrate according to claim 1, further comprising:
a third insulating layer on a side of the first conductive layer close to the base substrate; and
a fourth conductive layer on a side of the third insulating layer close to the base substrate, wherein the fourth conductive layer comprises a gate electrode of the thin film transistor and a gate line connected to the gate electrode, the gate line comprises a widening portion and a connecting portion, the gate electrode is located in the widening portion, the orthographic projection of the second electrode of the thin film transistor on the base substrate at least partially overlaps with an orthographic projection of the widening portion on the base substrate, and the orthographic projection of the second electrode of the thin film transistor on the base substrate does not overlap with an orthographic projection of the connecting portion on the base substrate.

12. The display substrate according to claim 11, wherein the orthographic projection of the protective electrode block on the base substrate at least partially overlaps with the orthographic projection of the widening portion on the base substrate; and
the orthographic projection of the protective electrode block on the base substrate at least partially overlaps with the orthographic projection of the connecting portion on the base substrate.

13. The display substrate according to claim 1, comprising a plurality of gate lines extending in the first direction, wherein the gate line is located between two adjacent rows of subpixel regions; and
the pixel electrode comprises a plurality of pixel electrode strips arranged at intervals in a region where the subpixel is located, the pixel electrode further comprises a first connecting portion and a second connecting portion, the first connecting portion is located on one side of the plurality of pixel electrode strips and connected to each of the plurality of pixel electrode strips, the second connecting portion is located on the other side of the plurality of pixel electrode strips and connected to each of the plurality of pixel electrode strips, the first connecting portion is connected to a second electrode of a corresponding thin film transistor through the first via hole, and an orthographic projection of the second connecting portion on the base substrate at least partially overlaps with an orthographic projection of a gate line on a corresponding side on the base substrate;
wherein an orthographic projection of the common electrode on the base substrate at least partially overlaps with the orthographic projection of the gate line on the base substrate.

14. The display substrate according to claim 1, comprising a plurality of gate lines extending in the first direction, wherein the gate line is located between two adjacent rows of subpixel regions, and two gate lines are arranged between every two adjacent rows of subpixel regions; wherein
the plurality of subpixels comprises a plurality of rows of subpixels respectively located in an i^{th} row and an (i+1)^{th} row and a plurality of columns of subpixels respectively located in a j^{th} column and a (j+1)^{th} column, wherein i is greater than or equal to 1, and j is greater than or equal to 1; and
the gate lines comprise a first gate line and a second gate line located between a region where the i^{th} row of subpixels is located and a region where the (i+1)^{th} row of subpixels is located, the first gate line is connected to a gate electrode of a thin film transistor of a subpixel in the i^{th} row and the (j+1)^{th} column, and the second gate line is connected to a gate electrode of a thin film transistor of a subpixel in the (i+1)^{th} row and the (j+1)^{th} column.

15. The display substrate according to claim 14, wherein the first via hole comprises a seventh side edge extending in the first direction, wherein
the seventh side edge in the i^{th} row of subpixels is located between the first gate line and the second gate line, and a distance between the seventh side edge and the second gate line is a fourth preset distance;
wherein the first via hole further comprises an eighth side edge extending in first direction, and an orthographic projection of the eighth side edge on the base substrate falls within the orthographic projection of the gate line on the base substrate; and the protective electrode block comprises a ninth side edge extending in the first direction, and an orthographic projection of the ninth side edge on the base substrate at least partially overlaps with the orthographic projection of the widening portion of the gate line on the base substrate, wherein a distance between the eighth side edge and the ninth side edge is a fifth preset distance;
the orthographic projection of the protective electrode block on the base substrate at least partially overlaps with the orthographic projection of the gate line on the base substrate, the protective electrode block comprises a protruding portion protruding relative to the gate line in the second direction, and the protruding portion is located between two adjacent gate lines, wherein the protruding portion has a first protruding distance in the second direction.

16. (canceled)

17. (canceled)

18. The display substrate according to claim 1, comprising a first subpixel located in an i^{th} row and a j^{th} column, a second subpixel located in the i^{th} row and a (j+1)^{th} column, and a third subpixel located in the i^{th} row and a (j+2)^{th} column, wherein the second subpixel comprises a second subpixel electrode; and
the display substrate further comprises a first data line located between the j^{th} column of subpixels and the (j+1)^{th} column of subpixels, and a first electrode line located between the (j+1)^{th} column of subpixels and the (j+2)^{th} column of subpixels,
wherein an orthographic projection of the second subpixel electrode on the base substrate at least partially overlaps with an orthographic projection of the first electrode line on the base substrate.

19. The display substrate according to claim 1, wherein the data line comprises a body portion and a connecting portion, and the connecting portion is connected to the first electrode of the thin film transistor, wherein the connecting portion extends in the second direction, an orthographic projection of the connecting portion on the base substrate at least partially overlaps with an orthographic projection of the main portion on the base substrate, the connecting portion has a third width in the first direction, the body portion has a fourth width in the first direction, and a ratio of the third width to the fourth width is between 0.8 and 1.2;
wherein the connecting portion protrudes relative to the body portion by a second protruding distance in the first direction, the body portion has a fourth width in the first direction, and the second protruding distance is greater than the fourth width.

20. (canceled)

21. (canceled)

22. The display substrate according to claim 1, comprising a plurality of gate lines extending in the first direction, wherein the gate line is located between two adjacent rows of subpixel regions and comprises a widening portion and a connecting portion, and two gate lines are arranged between every two adjacent rows of subpixel regions; and
the plurality of subpixels comprise a plurality of rows of subpixels respectively located in an i^{th} row and an (i+1)^{th} row, wherein i is greater than or equal to 1, the gate lines comprise a first gate line and a second gate line located between a region where the i^{th} row of subpixels is located and a region where the (i+1)^{th} row of subpixels is located,
wherein an orthographic projection of the common electrode on the base substrate at least partially overlaps with an orthographic projection of the widening portion of the first gate line on the base substrate, and an overlap between the orthographic projection of the common electrode and the orthographic projection of the widening portion of the first gate line has a first overlapping width in the second direction, and the first overlapping width is greater than or equal to 0.85 microns;
wherein the orthographic projection of the common electrode on the base substrate at least partially overlaps with an orthographic projection of a connecting portion of the second gate line on the base substrate, an overlap between the orthographic projection of the common electrode and the orthographic projection of the connecting portion of the second gate line has a second overlapping width in the second direction, and the second overlapping width is greater than or equal to 0.5 microns.

23. (canceled)

24. A display panel, comprising the display substrate according to claim 1.

25. A display apparatus, comprising the display substrate according to claim 1.
